(19) United States
(12) Patent Application Publication
(10) Pub. No.: US 2026/0099994 A1
(43) Pub. Date: Apr. 9, 2026

(54) REAL-TIME RADAR SIMULATION

(71) Applicant: NVIDIA Corporation, Santa Clara, CA (US)

(72) Inventors: Marius MONTEBAUR, Berlin (DE); Matthias Lehnen, Bonn (DE); Ayman Elsaeid, Berlin (DE)

(21) Appl. No.: 18/909,565

(22) Filed: Oct. 8, 2024

(51) Int. Cl. G06T 17/00; G01S 13/42; G01S 13/58; G01S 13/66; G01S 13/88

(52) U.S. Cl. CPC G06T 17/00; G01S 13/42; G01S 13/58; G01S 13/66; G01S 13/88

(57) ABSTRACT

Embodiments of the present disclosure relate to real-time radar model simulation. In operation, some embodiments first generate or receive simulation data representative of a simulated three-dimensional (3D) environment, where the simulated 3D environment includes one or more objects. Some embodiments additionally generate virtual sensor data via a virtual radar sensor within the simulated 3D environment. The virtual sensor data at least partially represents a manner in which one or more virtual radar signals emitted from the virtual radar sensor interact with the one or more objects within the simulated 3D environment. Based at least on generating the virtual sensor data via the virtual radar sensor within the simulated 3D environment, some embodiments extract one or more attribute values from the virtual sensor data. Based at least in part on the one or more attribute values, some embodiments populate a data structure representative of an output of the virtual radar sensor.

### BACKGROUND

Virtual sensors are software-based representations of real-world physical sensors that gather data from a simulated environment or system. They are integral components of simulation technologies in fields such as engineering, manufacturing, robotics, and autonomous vehicle systems. Virtual sensors generate synthetic data based on predefined algorithms, mathematical models, or real-world data patterns. These algorithms simulate the behavior of physical sensors by processing inputs from the simulated environment and producing corresponding outputs.

Radar is one of the most challenging sensors to simulate because of its operating requirements, especially with respect to signal processing. Real-world radar uses electromagnetic waves to detect the presence, location, speed, and other characteristics of objects in its vicinity. First, a radar transmitter continuously transmits frequency modulated (FM) signals in an environment. When the FM signals encounter objects in their path, they undergo various interactions. These interactions include reflection, scattering, diffraction, absorption, and/or transmission. At least some of the FM signals may reflect back toward the radar system when they encounter objects. These received signals are typically mixed with a reference signal. The reference signal is useful for conditioning the received signals and extracting useful information. Then, a series of Fast Fourier Transforms (FFT) is performed, along with threshold-based algorithms like constant false alarm rate (CFAR) to compute radar attributes (e.g., range, velocity, and azimuth). Radar signals often contain information in both the time domain and the frequency domain, and the FFTs are used to convert the received signals from the time domain to the frequency domain. Threshold-based algorithms like CFAR are used to distinguish between signals of interest (such as radar returns from targets) and noise or clutter.

### SUMMARY

Embodiments of the present disclosure relate to real-time radar model simulation. In operation, some embodiments first generate or receive simulation data representative of a simulated three-dimensional (3D) environment, where the simulated 3D environment includes one or more objects (e.g., virtual vehicles, pedestrians, buildings, street signs, traffic lights, and/or other potential obstacles). For example, various embodiments can employ scene authoring techniques to generate a virtual ego-machine as the virtual ego-machine traverses through a virtual environment.

Some embodiments additionally generate virtual sensor data via a virtual radar sensor within the simulated 3D environment. The virtual sensor data at least partially represents a manner in which one or more virtual radar signals emitted from the virtual radar sensor interact with the one or more objects within the simulated 3D environment. For example, the virtual sensor data can include ray tracing functionality that simulates how real-world radar signals propagate through a real-world environment and interact with real-world objects. In other words, rays are generated to simulate the radar's emission and reception process. The emitted rays propagate through the virtual scene, encountering virtual objects along their paths.

Based at least on generating the virtual sensor data via the virtual radar sensor within the simulated 3D environment, some embodiments extract one or more attribute values from the virtual sensor data. For example, one attribute value may include a virtual object's location. If one or more rays emitted from a virtual radar sensor intersect with a virtual vehicle (the “virtual object”) traveling on the road, the intersection points provide an indication of the location of the virtual vehicle in the simulated environment. This location could be expressed as coordinates (x_car, y_car, z_car), representing the position of the virtual vehicle relative to the virtual radar sensor.

Based at least in part on the one or more attribute values, some embodiments populate a data structure (e.g., a data cube) representative of an output of the virtual radar sensor. For example, a “range” dimension of a data cube represents the distance between the virtual radar sensor and the objects in the simulated environment. As described above, a ground truth attribute value may indicate the location of an object in 3D space (e.g., x, y, z coordinates). To compute the range dimension of the data cube, some embodiments calculate the distance from the virtual radar sensor's location to the object's location. Because the location of the object and virtual radar sensor (and/or other features) already exist as ground truth attribute values, various embodiments compute the data cube in manner that saves computing resources (e.g., via reduced latency and memory), while at the same time maintaining high fidelity and accuracy, as described in more detail below.

### BRIEF DESCRIPTION OF THE DRAWINGS

The present systems and methods for sensor simulation and learning sensor models with generative machine learning is described in detail below with reference to the attached drawing figures, wherein:

FIG. 1 illustrates an example virtual radar simulator system, in accordance with some embodiments of the present disclosure;

FIG. 2 illustrates an example simulated three-dimensional (3D) environment and how ground truth attributes are extracted, according to some embodiments of the present disclosure;

FIG. 3 is a schematic diagram illustrating how a data cube is generated from ground truth attributes, according to some embodiments of the present disclosure;

FIG. 4 is a flow diagram of an example method for populating a data structure representative of an output of a virtual radar sensor, according to some embodiments of the present disclosure;

FIGS. 5A-5F are example illustrations of a simulation system, in accordance with some embodiments of the present disclosure;

FIG. 6 is a flow diagram showing a method for generating a simulated environment using a hardware-in-the-loop (HIL) object, in accordance with some embodiments of the present disclosure;

FIG. 7A is an example illustration of a simulation system at runtime, in accordance with some embodiments of the present disclosure;

FIG. 7B includes a cloud-based architecture for a simulation system, in accordance with some embodiment of the present disclosure;

FIG. 8 includes a data flow diagram illustrating a process for re-simulation or simulation using one or more codecs, in accordance with some embodiments of the present disclosure;

FIG. 9 includes a data flow diagram for key performance indicator (KPI) analysis and observation, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Some embodiments relate to real-time radar simulation. In operation, some embodiments generate or receive simulation data representative of a simulated three-dimensional (3D) environment, where the simulated 3D environment includes one or more objects (e.g., virtual vehicles, pedestrians, buildings, street signs, traffic lights, and/or other potential obstacles). For example, various embodiments can employ scene authoring techniques to generate a virtual ego-machine as the virtual ego-machine traverses through a virtual environment. Scene authoring may include—as non-limiting examples—tasks such as modeling, texturing, shading, lighting, animation, and/or simulation.

Modeling is the process of creating 3D objects, structures, characters, and other assets that populate a scene or other simulation data (e.g., via the use of 3D modeling functionality, such as BLENDER). Texturing and Shading includes defining textures and materials (e.g., albedo material maps) to the 3D models to define their (e.g., realistic) appearances. This can include functions such as mapping textures to positions (e.g., vertices) of objects in a scene, and defining how materials react to light (e.g., via a Spatially-varying Bidirectional Reflectance Distribution Function (SVBRDF)). A Bidirectional reflectance Distribution Function (BRDF) is a function used to describe the reflectance properties of an object surface (or how light interacts with a surface). “Spatially-varying” BRDF means that reflectance properties change across a surface depending on the position of the corresponding object in relation to a light source, which affects the lighting (e.g., intensity, absorption, or scattering), the color of the object, the texture of the object, or other geometric features of the object (e.g., roughness, glossiness, etc.).

In an illustrative example, scene authoring techniques can generate a digital twin of a virtual ego-machine. In the context of ego-machine simulation, a digital twin typically refers to a highly detailed and realistic digital representation of a real-world ego-machine, its real-world components, and/or real-world conditions (e.g., lighting) by collecting and integrating data from one or more sources, such as sensors, IoT devices, and other data streams, to create a detailed and dynamic digital model. This digital model may mimic one or many real-world ego machine characteristics, behavior, and attributes in real time or near-real-time as the virtual ego-machine traverses through an environment.

Some embodiments additionally generate virtual sensor data via a virtual radar sensor within the simulated 3D environment. The virtual sensor data at least partially represents a manner in which one or more virtual radar signals (i.e., virtual electromagnetic waves (EWs)) emitted from the virtual radar sensor interact with the one or more objects within the simulated 3D environment. For example, a virtual radar on an outside surface of a virtual ego machine can capture virtual sensor data, which can be implemented using ray tracing techniques that simulate how real-world radar signals represented by the one or more virtual EWs propagate through a real-world environment represented by the simulated 3D environment and interact with real-world objects represented by the one or more objects. In other words, rays are generated to simulate the radar's emission and reception process. The emitted rays propagate through the virtual scene, encountering virtual objects along their paths.

When a ray intersects with an object, it can undergo reflection, absorption, transmission and/or refraction, depending on the material properties of the object. In radar simulation, reflection is particularly relevant, as it simulates how radar signals bounce off objects in the environment. Accordingly, various embodiments may additionally or alternatively track how the one or more virtual EWs scatter in one or more directions upon hitting one or more virtual surfaces of the one or more objects according to a Material Bidirectional Scattering Distribution Function (BSDF).

In the context of the present disclosure, BSDF is a mathematical function that describes how the virtual EWs interacts with a virtual surface of the one or more objects. BSDFs consider both incoming and outgoing virtual EW directions. This means they describe how the virtual EWs are scattered in different directions when it strikes the virtual surface, taking into account the incident angle of the incoming virtual EWs as well as the viewing angle of the virtual radar sensor. Radar signals may interact with surfaces in various ways: it can be absorbed, traverse through, or scatter in different directions. BSDFs specifically focus on the scattering aspect, determining how much of the virtual EWs is scattered into different directions upon hitting the virtual surface. The distribution part of BSDF refers to how the scattered virtual EWs are distributed across different directions. This aspect takes into account the virtual surface's material properties or microgeometry, such as its roughness or texture, which affects how light is scattered.

BSDF is a function that maps incoming virtual EW directions and outgoing virtual EW directions to corresponding intensity values. In mathematical terms, it gives the ratio of outgoing radiance (EW energy) to incoming irradiance (incident EW energy) for every possible pair of incoming and outgoing directions. Different materials exhibit different BSDFs due to their unique optical properties. For example, a glossy surface like polished metal will have a very different BSDF compared to a diffuse surface like chalk. These BSDFs encapsulate characteristics such as reflectivity, translucency, roughness, and anisotropy.

In some embodiments, the sensor data is additionally or alternatively indicative of energy transport simulation by converting a portion of the sensor data to estimated energy of the one or more virtual EWs based on polarization and phase. “Energy transport simulation” involves simulating the propagation of the virtual EWs as they travel through space or interact with the objects in the virtual environment. Polarization refers to the orientation (e.g., linear, circular, or elliptical state) of the electric field component of a virtual EW, while phase refers to the relative timing or position of the virtual EW. Certain materials or surfaces may preferentially reflect or scatter radar signals with specific polarization orientations. Accordingly, various embodiments map material properties (e.g., via material ID and behavior according to BSDFs) to certain polarization orientations.

Phase information can be used to compare the timing or phase shift of the virtual EWs between transmission and reception. This comparison can provide insights into the distance traveled by the radar signals and the relative motion of objects in the radar's field of view or vice versa. By measuring the phase difference between transmitted and received virtual EWs, various embodiments estimate the range or distance to detected virtual objects, as well as their velocity (Doppler shift). This information can be used to determine the energy levels of the virtual radar sensor returns, as objects at different distances or velocities may exhibit different levels of radar reflectivity.

Once polarization and phase information has been extracted from radar returns of the virtual EWs, it can be used to compute energy levels or signal strength of the virtual EWs. In one or more embodiments, the energy of a radar return can be computed as a function of amplitude, phase, and polarization. By quantifying the polarization characteristics, phase relationships of radar returns, and material properties, it is possible to estimate the energy levels of the virtual EWs.

Based at least on the virtual sensor data, some embodiments extract one or more attribute values from the virtual sensor data. Such attributes represent “ground truth” values that embodiments use to make additional computations. For example, such attributes may include at least one of: an indication of a location of the one or more objects, a velocity vector of the one or more objects, an identifier of one or more materials of the one or more objects, a behavioral characteristic of the one or more virtual EWs when interacting with the one or more materials, a round trip distance associated with the one or more virtual EWs, and a roundtrip velocity associated with the one or more virtual EWs.

Based at least in part on the one or more attribute values, some embodiments populate a data structure (e.g., a data cube) representative of an output of the virtual radar sensor. For example, in some embodiments, the data structure represents a vector with multiple dimensions, such as a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

In an illustrative example, the “range” dimension of a data cube represents the distance between the virtual radar sensor and the objects in the simulated environment. Ground truth attributes may provide the location of each object in 3D space (x, y, z coordinates). To compute the range dimension of the data cube, various embodiments calculate the Euclidean distance from the virtual radar sensor's location to each object's location. This distance represents the range or radial distance between the virtual radar sensor and the object, which can then be populated in the data cube.

Various embodiments of the present disclosure have various technical effects and benefits relative to existing radar simulation technologies. As described above, real-world radar is challenging to simulate given their signal processing requirements. Some existing technologies try to simulate such signal processing described above by reconstructing an antenna signal in the time domain and then perform FFT on that signal. But this is associated with increased compute latency due to all the signal processing algorithms that must be performed to accomplish this processing task. Such technologies also require a very large memory footprint to store simulated high fidelity signals that the radar receives. Other technologies try to close this gap by simplifying the simulation (e.g., via the use of depth buffers). But in doing so, they sacrifice fidelity or radar simulation accuracy. Various embodiments thus have the technical effect of reduced memory consumption and reduced compute latency without sacrificing fidelity or accuracy. This is at least partially because some embodiments do not imitate a specific wave form or profile (i.e., reconstruct an antenna signal) for signal processing as existing technologies do, but they rather imitate and track radiation patterns (e.g., via ray tracing) of virtual EWs to derive already-existing ground truth attributes. In other words, various embodiments “skip” antenna signal reconstruction steps performed by existing technologies (thereby reducing latency and memory consumption) while at the same time computing the dimensions (e.g., range, azimuth, etc.) needed for radar output processing, thereby maintaining fidelity and accuracy. For instance, particular embodiments fill in a data cube without having to reconstruct and Fourier-transform a time-domain antenna signal, unlike existing technologies.

The systems and methods described herein may be used by, without limitation, virtual representations of: non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Virtual Radar Simulator System

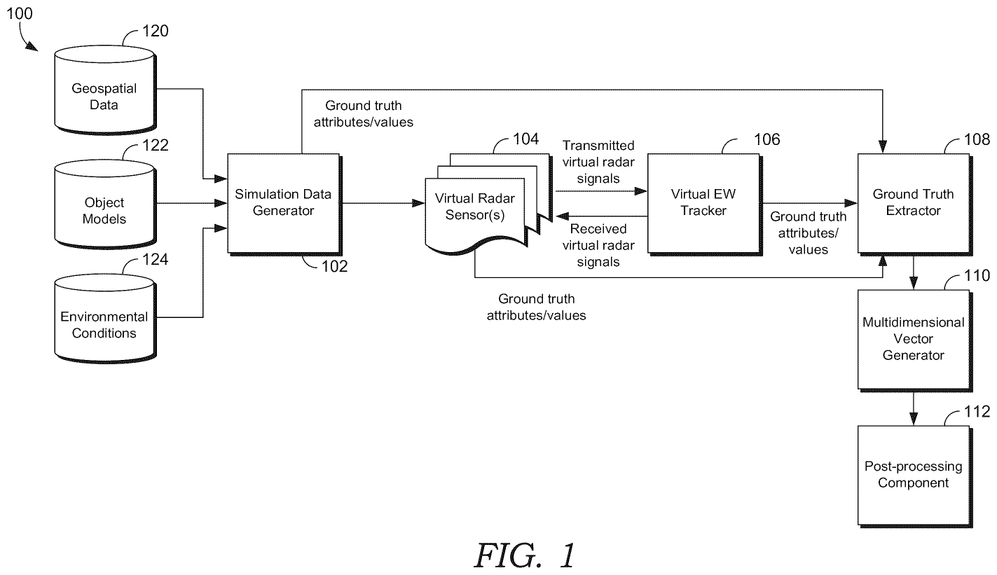

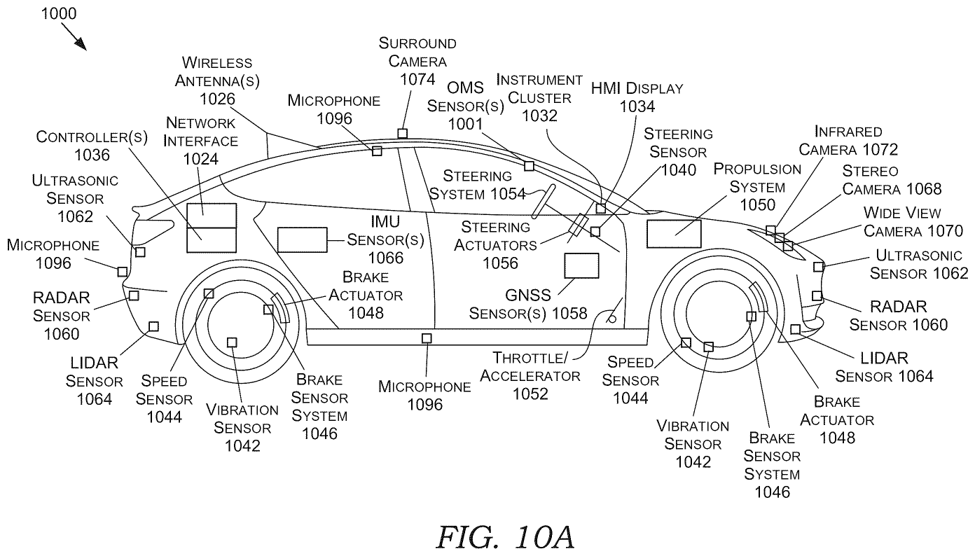

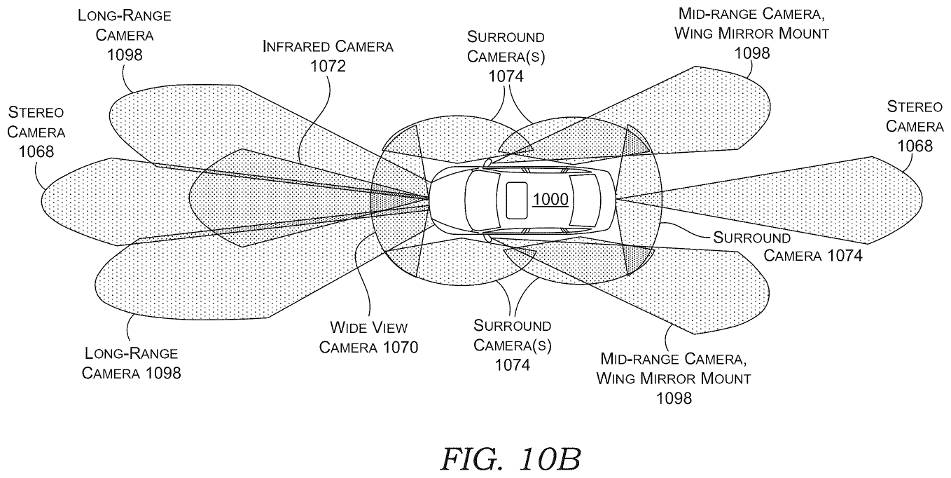

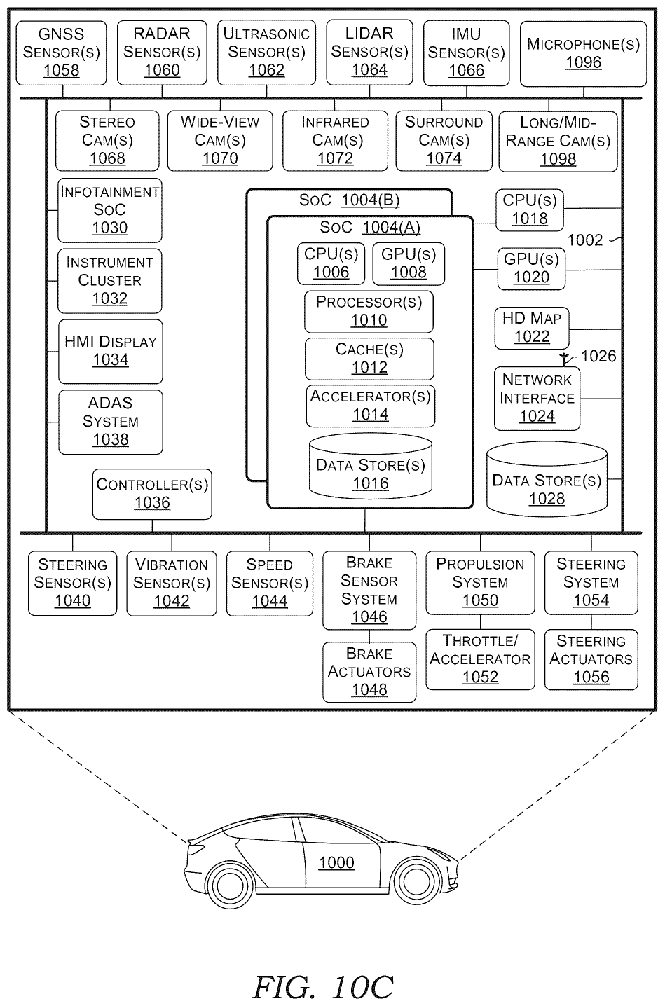

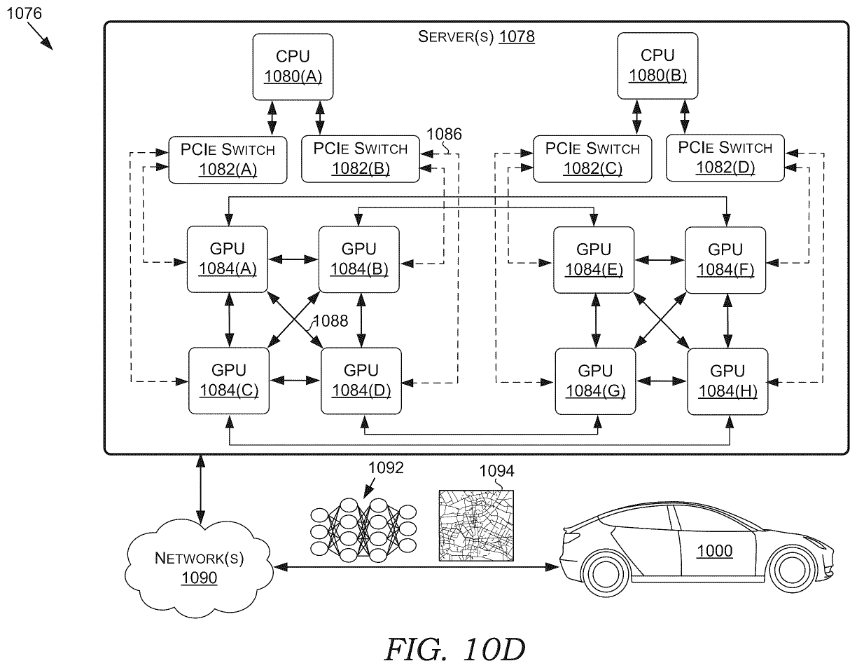

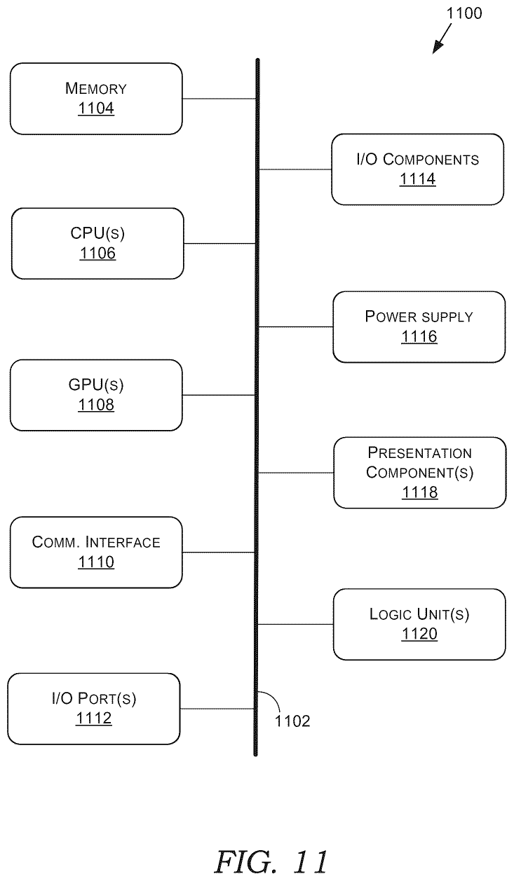

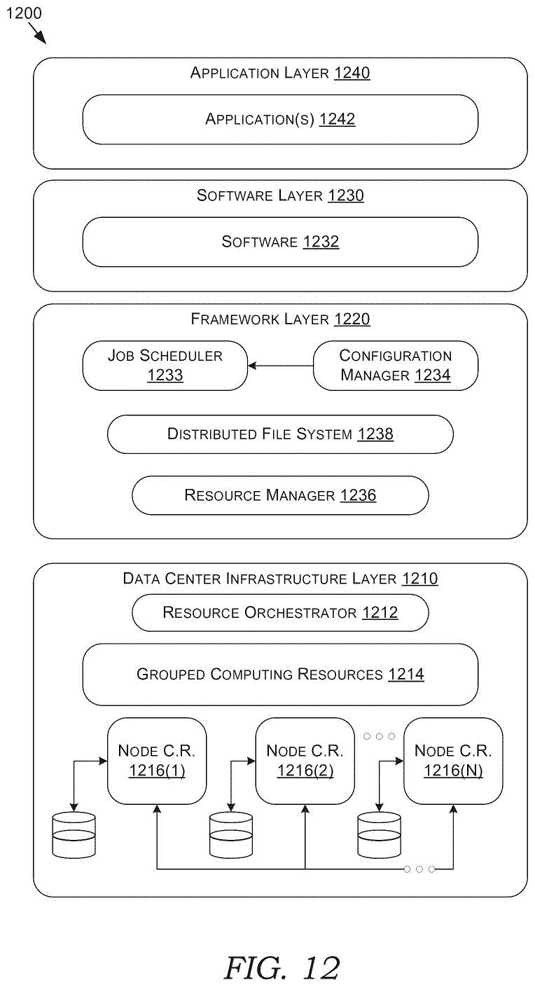

With reference to FIG. 1, FIG. 1 illustrates an example virtual radar simulator system 100 (referred to as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

As a high level overview, the system 100 generates radar simulation data. The system 100 includes a simulation data generator 102, one or more virtual radar sensors 104, a virtual Electromagnetic Wave (EW) tracker 106, a ground truth extractor 108, a multidimensional vector generator 110, and a post-processing component 112

At a first time, the simulation data generator 102 generates simulation data (e.g., a simulated 3D environment) using the geospatial data 120, object models 122, and environmental conditions 124 as input. For example, the simulation data generator 102 initializes a virtual scene representing a real-world environment in which the virtual radar sensor(s) 104 operates. This scene may include objects like ego-machines, pedestrians, buildings, and/or other potential obstacles.

Geospatial data 120 includes information about the terrain, roads, intersections, and other geographical features relevant to the simulated environment. Geospatial data may be obtained from mapping services, geographic information systems (GIS), or custom-designed maps. Object models 122 include digital representations and/or descriptions of vehicles, pedestrians, buildings, foliage, road signs, and other objects present in the simulated environment. In some embodiments each of these object models provide metadata details such as dimensions, material properties, and behavior characteristics of a corresponding object. Examples of material properties include texture, color, reflectivity, transparency, and roughness. These properties affect how objects interact with light and other electromagnetic signals (e.g., the virtual radar sensor(s) 104), influencing their appearance and behavior within the simulation. As described above scene authoring techniques or other models (e.g., Blender) may generate object models.

Environmental conditions 124 include parameters such as weather conditions (e.g., clear, rainy, foggy), time of day, lighting conditions (e.g., natural sunlight, artificial lighting), and atmospheric effects (e.g., haze, pollution) that influence the simulation. In some embodiments, traffic patterns may be another input used by the simulation data generator 102 to generate simulation data. Traffic patterns include information about vehicle and pedestrian movement patterns, including routes, speeds, accelerations, and interactions between different entities.

Using one or more of the input data from 120, 122, and 124, the simulation data generator 102 generates a virtual scene that accurately represents the real-world environment where the virtual radar sensor(s) 104 operates. This involves placing objects according to their specified locations and orientations within the simulated space. In some embodiments, the simulation data generator 102 additionally generates simulation data based on initialization parameters. Initialization parameters include settings related to the size of the simulation area, the resolution of the scene, the level of detail for objects, and other simulation-specific parameters. These parameters ensure that the virtual environment is configured to meet the requirements of the radar sensor simulation, balancing realism with computational efficiency. Once the virtual scene is initialized, it may undergo verification and validation processes to ensure that it accurately represents the intended real-world environment and meets the requirements of the radar sensor simulation. Verification, for example, may involve checking the correctness of the scene generation process, while validation involves comparing simulated behavior against observed or expected real-world behavior.

The virtual radar sensor(s) 104 is responsible for transmitting one or more virtual radar signals (virtual EWs) into the virtual scene/simulation data generated by the simulation data generator 102 and detecting/receiving corresponding EWs back by taking, as input, the virtual scene, objects, and/or other simulation data generated by the simulation data generator 102. The virtual radar sensor(s) 104 may be included in or represent any suitable virtual radar that represents any suitable real-world radar. For example, such virtual radar may represent a primary radar, a secondary radar, a Doppler radar, a Synthetic Aperture Radar (SAR), a Ground Penetrating Radar (GPR), a meteorological radar, a phased array radar, a Frequency Modulated Continuous Wave (FMCW) radar, and/or the like. The virtual EW tracker 106 is generally responsible for tracking the paths of the virtual EWs and determining virtual EW characteristics (e.g., absorption, scattering, etc.), as described below.

In some embodiments, ray tracing is employed by the virtual radar sensor(s) 104 and/or the virtual EW tracker 106 in radar simulation to mimic the propagation and detection of radar signals within the virtual environment generated by the simulation data generator 102. For example, the virtual radar sensor(s) 104 may first emit rays (virtual EWs) from the virtual radar sensor 104's location. These rays represent electromagnetic signals transmitted by a radar. The number and distribution of rays depend on the radar's characteristics (e.g., antenna radiation pattern and field of view).

The emitted rays propagate through the virtual environment, following straight-line paths until they encounter objects. Ray tracing algorithms (which may include the virtual EW tracker 106) simulate the propagation of radar signals by calculating the paths of the rays as they interact with the scene geometry. An example of a ray tracing algorithm used to simulate the propagation of radar signals is the “ray-object intersection” algorithm. This algorithm calculates the paths of individual rays emitted by the virtual radar sensor(s) 104 and determines (e.g., via the virtual EW tracker 106) how they interact with objects in the scene geometry. The algorithm starts by initializing parameters such as the position and orientation of the virtual radar sensor(s) 104, the characteristics of the radar waves (e.g., wavelength, frequency), and the geometry of the scene (e.g., objects, terrain).

Rays are emitted from the virtual radar sensor 104's position in a predetermined direction, representing the transmission of radar signals into the environment. The number, repetition, and distribution of rays depend on factors such as the radar's beam width and resolution. Each emitted ray follows a straight-line path through the scene geometry, propagating until it intersects with an object or reaches the maximum range of the radar sensor. The algorithm calculates the intersection point and distance traveled by the ray.

When a ray intersects with an object in the scene, the virtual EW tracker 106 checks for collisions between the ray and the object's geometry. This involves determining whether the ray intersects with any surfaces or volumes of the object. Depending on the properties of the object's surface (e.g., material, roughness), the virtual EW tracker 106 simulates reflection, refraction, and absorption of the virtual radar signal. For example, a smooth, metallic surface may result in specular reflection, while a rough, absorbent surface may scatter the signal in multiple directions.

As the ray propagates through the environment, it may experience attenuation due to factors such as distance traveled, atmospheric conditions, and material properties. The algorithm adjusts the intensity of the ray based on these factors. If a ray intersects with an object and is not absorbed and is reflected back to the sensor, it “contributes” to the radar detection process. Thus, the ray tracing functionality may include aggregating a list of contribution rays that point towards virtual radar sensor receivers. These contributions are then processed by a virtual radar sensor model (e.g., the virtual EW tracker 106) to approximate a multidimensional data structure, as described in more detail below. The virtual EW tracker 106 records information about the intersection point, including the object's position, orientation, and velocity, which may be used to estimate the object's attributes.

The virtual EW tracker 106 continues tracing rays until the rays: reach the maximum range of the radar sensor 104, exceed the number of minimum number of bounces, or exit the scene geometry. Rays that do not intersect with any objects or reach the maximum range are terminated. In some embodiments, the results of the ray tracing simulation are represented as a data set containing information about the detected objects and their attributes. This data can be organized into formats such as point clouds, radar maps, or radar images for further analysis and visualization.

In an illustrative example of the virtual radar sensor(s) 104 and the virtual EW tracker 106, a virtual radar sensor 104 is located on a vehicle in a simulated urban environment generated by the simulation data generator 102. The virtual radar sensor 104 emits rays in all directions, simulating its field of view (i.e., representing the “transmitted virtual radar signal(s) if FIG. 1). These rays intersect with nearby objects such as parked cars, pedestrians, and buildings, as tracked by the virtual EW tracker 106. When a ray intersects with a car, it reflects off the car's surface and carries information about the car's orientation and speed back to the virtual radar sensor 104 (i.e., representing the “received virtual radar signal(s)” in FIG. 1). This contributes to the virtual radar sensor(s) 104 detection of the car. Similarly, rays that intersect with buildings or other structures undergo reflection or absorption, providing information about the environment's layout and potential obstacles. By tracing the paths of these rays and simulating their interactions with objects in the scene, the virtual radar sensor(s) 104 generates a realistic representation of the environment and accurately detects objects within its field of view.

In some embodiments, the virtual radar sensor(s) 104 and/or the virtual EW tracker 106 detects additional or alternative attributes. Examples of such attributes include: simulation of a noise floor that creates inaccuracies in radar target detection, multi-path effects that allow detecting radar objects without a clear line of sight, aliasing effects, wrapping of values after they exceed the measurement-limits of the simulated radar, FOV (field of view), resolution and separation characteristics of a real radar, definition of antenna gain pattern to resemble a real radar's directional sensitivity, and micro Doppler effects, which are described in more detail below.

The noise floor refers to the baseline level of noise present in the radar system, which can affect the accuracy of target detection. In the simulation data, some embodiments introduce a noise floor component that adds random noise to the radar returns. This noise can be modeled using, for example, statistical distributions such as Gaussian noise. The amplitude of the noise floor can be adjusted based on system parameters and environmental conditions.

Multipath propagation occurs when radar signals travel along multiple paths between the transmitter (radar sensor) and receiver (radar target) due to reflections, diffractions, and scattering from objects in the environment. In the simulation, various embodiments model multipath propagation by simulating the reflection, diffraction, and/or scattering of virtual radar signals off objects in the virtual scene. Ray tracing or wave propagation models, for example, can be used to calculate the paths of radar signals and their interactions with the environment. Objects in the environment, such as buildings, vehicles, and terrain features, reflect and scatter radar signals in multiple directions. The simulated radar signals can interact with these objects and produce reflected signals that arrive at the radar sensor from different directions. By modeling the reflective properties of objects and the geometry of the environment, various embodiments thus simulate the multipath effects that contribute to detecting radar objects without a clear line of sight.

In the simulation, in some embodiments the virtual radar measurements are represented as discrete samples collected at regular intervals. Aliasing occurs when the sampling rate is insufficient to accurately represent the frequency content of the radar signal, leading to distortions in the measured data. To simulate aliasing effects, some embodiments adjust the sampling rate and resolution of the simulated radar measurements. Lowering the sampling rate or reducing the resolution can introduce aliasing artifacts, where high-frequency components of the radar signal are incorrectly represented by lower-frequency components.

The field of view of a radar sensor defines the angular range over which it can detect objects. To simulate the FOV, some embodiments define the angular limits within which the virtual radar sensor(s) 104 operates. Objects outside the defined FOV are not detected by the virtual radar sensor(s) 104 during the simulation. In some embodiments, ray tracing or geometric modeling techniques can be used to determine which objects fall within the FOV of the radar sensor and simulate their detections accordingly. Radar resolution refers to the ability of the radar sensor to distinguish between closely spaced objects. Separation characteristics determine the minimum distance between two objects that can be resolved as separate targets. In the simulation, some embodiments define the resolution and separation capabilities of the virtual radar sensor(s) 104 based on its technical specifications. Objects that are closer together than the specified resolution or separation distance may be detected as a single target or may not be resolved at all, depending on the simulation parameters. The resolution and separation characteristics can be implemented using geometric modeling to analyze the simulated radar returns.

The antenna gain pattern represents the directional sensitivity of the radar antenna, indicating how its gain (radiation intensity) varies with angle relative to its axis. To simulate the antenna gain pattern, some embodiments define the radiation pattern of the virtual radar sensor 104′ antenna based on its technical specifications. Example antenna patterns include isotropic, omnidirectional, directional, and sectored patterns, each with different characteristics. The antenna gain pattern can be modeled using mathematical functions or empirical data obtained from antenna measurements, such as isotropic patterns, Cosine patterns (e.g., Cosine Square Pattern), Dipole pattern, or the like. The simulated antenna gain pattern is incorporated into the radar sensor model to represent its directional sensitivity.

During the simulation, in some embodiments virtual radar signals emitted and received by the antenna are modulated by the gain pattern, affecting the strength of the detected signals based on their direction of arrival. Objects located within the main lobe of the antenna gain pattern experience higher signal strength and are detected more easily, while objects outside the main lobe may be detected with reduced sensitivity or not detected at all.

The ground truth extractor 108 is generally responsible for extracting or receiving attributes and/or or values by taking, as input, information from the simulation data generator 102, virtual radar sensor(s) 104, and the virtual EW tracker 106. For example, the simulation data generator 102 may generate an object in the simulated environment, with a material property of X, where both the attribute (material property) and value (X) is passed on to the ground truth extractor 108 (and the virtual EW tracker 106). The virtual EW tracker 106 may then predict or determine that a corresponding virtual EW will have characteristic Y (e.g., it will absorb, scatter, or reflect back) based on the material property. Both material property X and characteristic Y (as attribute-value pairs), for example, are passed to the ground truth extractor 108 for use in generating a multidimensional vector, as described in more detail below with respect to the multidimensional vector generator 110. In some embodiments, the ground truth extractor 108 generates or populates a key-value pair data structure, where each key represents a particular attribute, such as material properties, and each value represents a corresponding value, such as a specific material property value of reflectivity, transparency, opacity, roughness, color, dielectric constant, conductivity, magnetic permeability, and/or emissivity.

The ground truth extractor 108 may extract any suitable quantity of attributes and corresponding values from the simulation data generator 102, the virtual radar sensor(s) 104, and/or the virtual EW tracker 106. For example, the ground truth extractor 108 may extract one or more of the following: an indication of a location of the one or more objects, a velocity vector of the one or more objects, an identifier of one or more materials of the one or more objects, a behavioral characteristic of the one or more virtual EWs when interacting with the one or more materials, a round trip distance associated with the one or more virtual EWs, or a roundtrip velocity associated with the one or more virtual EWs.

Simulating a scene, virtual radar sensor, and ray tracing can be used to extract various ground truth attribute values related to detected objects and the behavior of radar signals. Regarding location of objects, by tracing the paths of rays emitted from the virtual radar sensor and calculating their intersections with objects in the scene (e.g., as determined by the virtual EW tracker 106), the positions of detected objects can be determined. The intersection points provide the location coordinates of the objects relative to the radar sensor. These locations are typically represented as 3D coordinates (x, y, and z) in the simulation space. For instance, if multiple rays emitted from the virtual radar sensor 104 intersect with different portions of a virtual car traveling on the road, the intersection points collectively indicate a location of the car in the simulated environment. This location could be expressed as coordinates (x_car, y_car, z_car), representing the position of the car relative to the radar sensor.

In some embodiments, the velocity vector of detected objects is derived from the Doppler shift of the returned radar echoes. Changes in the frequency of the reflected or return signals (e.g., the “received virtual radar signal(s)” of FIG. 1) compared to the transmitted signals (e.g., the “transmitted virtual radar signal(s)” of FIG. 1) indicate the relative velocity of the objects along the radar line-of-sight direction. The virtual EW tracker 106 detects such change in frequency. Regarding the identifier of materials of objects, the simulation data generator 102 assigns material properties to objects in the scene during scene initialization. Alternatively or additionally, the ground truth extractor 108 may alternatively or additionally directly call the simulation data generator 102 to derive the material properties of an object (e.g., where an intersection point between ray and object is).

Regarding the behavioral characteristic of rays, the behavior of rays when interacting with materials in the scene can be characterized by the virtual EW tracker 106 based on attributes such as reflection, refraction, absorption, and scattering. By analyzing the changes in ray direction, intensity, and polarization after interaction with materials, the behavioral characteristics of the rays can be determined.

Regarding round trip distance associated with rays, the round trip distance traveled by rays can be calculated by the virtual EW tracker 106 based on the intersection points of the rays with objects in the scene. For example, when the virtual radar sensor(s) 104 propagate the “transmitted virtual radar signal(s)” in virtual space, it may also transmit its location identifier indicating its location in the virtual scene. Upon detecting an intersection point, the virtual EW track 106 (having received such transmitted virtual radar signal(s) and location identifier) may first calculate the distance traveled by the “transmitted virtual radar signal(s)” by calculating a distance between the location identifier corresponding to the virtual sensor 104's location and a second location identifier indicating an object's location (where intersection has been detected). In order to get the “round trip” distance, the virtual EW tracker 106 may multiply such value by 2 (representing the “received virtual radar signal(s)”).

The round trip velocity of rays can be derived by calculating and then adding each object's relative velocity. Overall, the combination of simulating a scene, virtual radar sensor, and ray tracing provides a comprehensive framework for extracting ground truth attribute values related to detected objects and the behavior of radar signals in a simulated environment.

The multidimensional vector generator 110 is generally responsible for taking, as input, the attribute-value pairs determined by the ground truth extractor 108, in order to compute one or more multidimensional vectors (e.g., a data cube) representative of an output of the virtual radar sensor(s) 104. From the simulated scenario, the ground truth extractor 108 obtains ground truth attributes for detected objects, including their location, velocity vector, and material properties. The multidimensional vector and associated functionality is described in more detail below.

In some embodiments, the output of the multidimensional vector generator 110 includes one or more detected objects. In some embodiments, the resulting detections are post-processed, via the post-processing component 112, to add noise effects and encoded into a vendor-specific format and sent via network to, for example, a perception stack. This means that after the radar data has been processed and detections have been made, additional steps are taken to prepare the data for further analysis by the perception stack. One aspect of this post-processing involves adding noise effects to the detections. This is done to simulate real-world conditions where radar signals may be corrupted by noise from various sources such as environmental interference, hardware limitations, or signal processing artifacts. Adding noise effects helps ensure that the perception stack receives radar data that more closely resembles the actual data it would encounter in operational scenarios, thereby improving the robustness and effectiveness of the perception algorithms.

Once the radar detections have been post-processed, they are encoded into a format that is specific to the vendor's system or hardware. Different radar systems may use proprietary data formats to represent radar detections, which may include information such as target position, velocity, size, and confidence scores. Encoding the detections into a vendor-specific format ensures compatibility with the perception stack and facilitates seamless integration with other components of the system. Finally, the encoded radar detections are transmitted over a network to the perception stack, which is responsible for processing and interpreting the data to make decisions or take actions. The perception stack does not typically discern whether the data comes from a real sensor or a simulated one. This transmission typically occurs in real-time or near-real-time to support time-critical applications such as autonomous driving, robotics, or surveillance. By sending the radar data to the perception stack, it can be fused with data from other sensors/virtual sensors (such as virtual cameras, Lidar, or ultrasonic sensors) to provide a comprehensive understanding of the surrounding environment and enable higher-level decision-making.

In an illustrative example, in an autonomous vehicle system, virtual radar sensors detect objects in the vehicle's vicinity of a simulated environment. After processing and detecting objects, the system may add simulated noise effects to the detections to mimic real-world sensor imperfections. The detections are then encoded into a format specific to the virtual vehicle's virtual radar system and transmitted over a network to the perception stack onboard the vehicle. The perception stack integrates virtual radar data with information from other virtual sensors (such as cameras and Lidar) to analyze the environment, identify obstacles, and make driving decisions such as collision avoidance or lane-keeping.

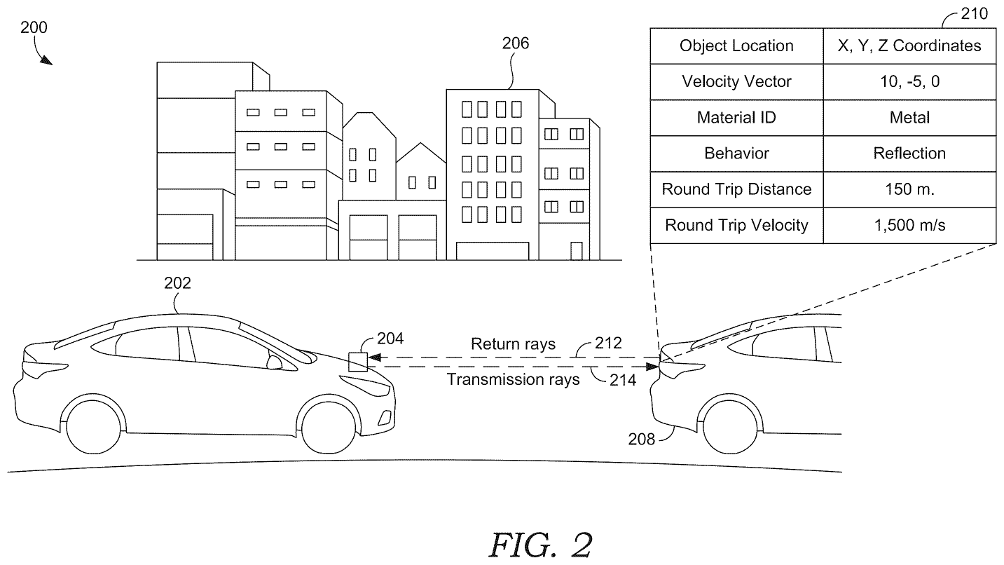

FIG. 2 illustrates an example simulated three-dimensional (3D) environment 200 and how ground truth attributes are extracted, according to some embodiments. In some embodiments, the simulation data generator 102 generates the simulated 3D environment 200. The simulated 3D environment includes various objects, such as virtual vehicle 202, virtual vehicle 208, and virtual buildings 206.

The virtual radar sensor 204 (e.g., a front virtual radar) is located on a frontal surface of the virtual vehicle 204. The virtual radar sensor 204 (e.g., the virtual radar sensor(s) 104) sends primary rays 214 into virtual space within the simulated 3D environment 200. The primary rays 214 bounce off of and reflect off of a back portion of the virtual vehicle 208 and are represented as the return rays 212, as illustrated in FIG. 2. Responsively, the virtual radar 204 detects the virtual vehicle 208. As described herein, ray tracing and the virtual EW tracker 106 may be used to trace these primary and return rays 214 and 212 respectively and store associated information indicated in the key-value pair data structure 210. In some embodiments, the key-value pair data structure 210 represents the data structure generated or populated by the ground truth extractor 108 as described with respect to FIG. 1.

The following describes the attributes and their values within the data structure 210. The “object location” represents the virtual vehicle's 208 location at the point of intersection (when the primary rays 214 touch a surface of the virtual vehicle 208). The “velocity vector” represents the velocity, in X, Y, and Z directions of the virtual vehicle 208. The “material ID” represents the type of material the virtual vehicle 208 is at the point of intersection. The “behavior” represents the predicted behavioral characteristic of the primary rays 214 once it hits the virtual vehicle 208. As illustrated in FIG. 2, the predicted characteristic is a “reflection” of the primary rays 214 back to the virtual sensor 204, which is represented by the return rays 212. The “round trip distance” attribute represents the distance the primary rays 214 and the return rays 212 travel, where the origin and stopping point is the radar 204 and an intermediate stopping point is the virtual vehicle 208. The “round trip velocity” attribute represents a combined velocity of the primary rays 214 and the return rays 212.

The following describes how various attribute values within the data structure 210 may be calculated. For example, the X-axis of the velocity vector may be calculated as follows:

The “round trip distance” is the total distance traveled by the radar signal (a combination of the primary rays 214 and return rays 212) from the radar sensor 204 to the virtual vehicle 208 and back to the radar sensor 204. It represents the sum of the distances covered during transmission and reflection. For example, the radar sensor 204 is located at a fixed position Dₛₑₙₛₒᵣ meters away from the virtual vehicle 208, and the virtual vehicle 208 is located at a distance D_{car} meters from the radar sensor 204. The velocity of a vehicle can be measured with radar by looking at a single EW, which is sent out and received in a matter of milliseconds. The change in distance between the radar sensor and the other vehicle in this small time frame is enough to calculate the velocity of the vehicle.

To calculate the round trip velocity in the given example above, where a radar signal is transmitted from a radar sensor 294, reflects back from another virtual vehicle 208, and returns to the radar sensor 204, some embodiments measure the time taken for the radar signal to travel from the radar sensor 204 to the virtual vehicle 208 and back to the radar sensor 204, where this time is denoted as t_{round-trip}. Various embodiments calculate the round trip distance traveled by the radar signal using the formula mentioned earlier:

Dround-trip=Dsensor+Dcar.

Round trip velocity (V_{round-trip}) is the velocity of the radar signal relative to the radar sensor.

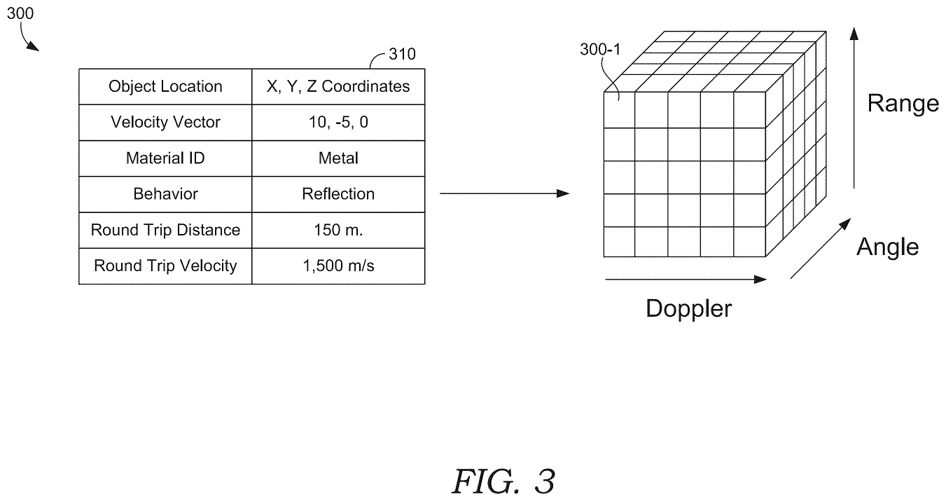

FIG. 3 is a schematic diagram illustrating how a data cube 300 is generated from ground truth attributes 310, according to some embodiments. The data cube 300 is a three-dimensional grid (e.g., a vector), where each cell (or bin) (such as 300-1) represents a unique combination of the three dimensions—range, Doppler, angle (e.g., azimuth and/or elevation) values. In some embodiments, the quantity of data cube bins define the virtual radar sensor's resolution and separation capabilities. Separation capabilities refer to the radar's ability to resolve distinct targets or objects in the environment, even when they are located close together or have similar radar signatures. Increasing the number of bins in the data cube 300 improves the virtual radar's separation capabilities by providing finer discrimination between targets and reducing the likelihood of false alarms or ambiguity in target detection. In a real-world or simulated scenario, a data cube is typically filled from several FFTs on the output signal of the radar signal. Each bin in the FFT output represents a frequency component that contributes to the overall radar detection process. But as described herein, such process leads to increased compute latency and extensive memory consumption.

In some embodiments, the data cube 300 and these three dimensions represent the output of a real radar sensor with a sufficient level of accuracy, except that the bins are derived from ground truth attributes, as opposed to representing signal processing attributes (e.g., frequency ranges for FFT outputs). These dimensions in FIG. 3 define the spatial and velocity characteristics of radar detections. It is understood that while the data cube includes 3 specific dimensions (range, Doppler, and angle), any quantity or combination of dimensions may exist depending on the type of radar and/or requirements of a given simulation scenario. For example, alternative or additional dimensions of polarization, time, clutter characteristics, radar mode, target classification, and/or environmental conditions may be present in the data cube 300.

Ground truth attributes, as illustrated in the data structure 310 (e.g., data structure 210) for detected objects are obtained from a simulated radar scenario, such as illustrated in FIG. 2. These attributes include position (represents the 3D coordinates (x, y, z) of detected objects relative to the virtual radar sensor), velocity (represents the velocity vector of detected objects relative to the virtual radar sensor, including both speed and direction), material properties (represents the material composition of detected objects, influencing their radar reflectivity and scattering behavior). There may be alternative or additional attributes.

Each detected object in a simulated environment contributes to the population of bins in the data cube 300 based on its ground truth attributes 310. For example, with respect to the “range” dimension, it represents the radial distance from the virtual radar sensor to the detected object(s) (e.g., the virtual vehicle 208). The virtual EW tracker 106 calculates the distance from the virtual radar sensor to each detected object using their ground truth locations (object location).

Various embodiments consider any round trip distances if applicable, which account for the travel distance of the radar signal from the sensor to the object and back. Various embodiments, such as the multidimensional vector generator 110, then define the range bins, which may be fixed and defined by the radar sensor to be simulated. In an illustrative example, the “range” dimension or axis is divided into bins of 10 meters each, ranging from 0 to 100 meters. Each bin corresponds to a specific distance from the radar sensor, allowing embodiments to understand the spatial distribution of detected objects along the range.

With respect to the “Doppler” dimension, it captures the velocity component of detected objects along the radar line-of-sight direction. Various embodiments calculate the Doppler shift of the radar returns from the detected objects using their velocity vectors. Doppler shift can be computed based on the relative velocity between the virtual radar sensor and the object along the line-of-sight direction. The multidimensional vector generator 110 then defines the Doppler bins, which may be fixed by sensor parameters of the sensor model. For example, the Doppler axis is divided into bins of 2 m/s each, ranging from −10 to 10 m/s. Each bin represents a range of Doppler frequencies or velocities observed in the radar returns. Positive values indicate objects moving away from the radar sensor, while negative values indicate objects moving towards the sensor.

With respect to “elevation angle” and “azimuth angle” dimension, they define the angular position of detected objects relative to the virtual radar sensor's reference direction. Some embodiments calculate the elevation angle and azimuth angle of each detected object based on their locations relative to the virtual radar sensor. The multidimensional vector generator 110 then defines the elevation and azimuth bins based on the angular coverage of the radar sensor fixed by sensor parameters.

Regarding material properties and ray behavior, they can influence radar signal propagation and interaction with objects. Various embodiments consider the material properties of detected objects to determine their radar cross-sections and scattering characteristics. Various embodiments use ray behavior information (e.g., reflection versus absorption) to model the behavior of radar signals interacting with objects and the surrounding environment. These factors may affect the intensity and phase of radar returns, which can further inform the population of bins in the data cube 300.

In some embodiments, the populated data cube 300 is visualized using various techniques such as 3D scatter plots, heat maps, or contour plots as illustrated in FIG. 3. Visualization helps in understanding the spatial distribution and characteristics of radar detections, identifying patterns, anomalies, or areas of interest in the simulated environment. By populating the data cube 300 based on ground truth attributes 310 and binning techniques, the data cube 300 accurately captures the spatial, velocity, and material properties of radar detections in the simulated environment. This comprehensive representation facilitates analysis, evaluation, and optimization of radar systems in various applications such as autonomous driving simulations.

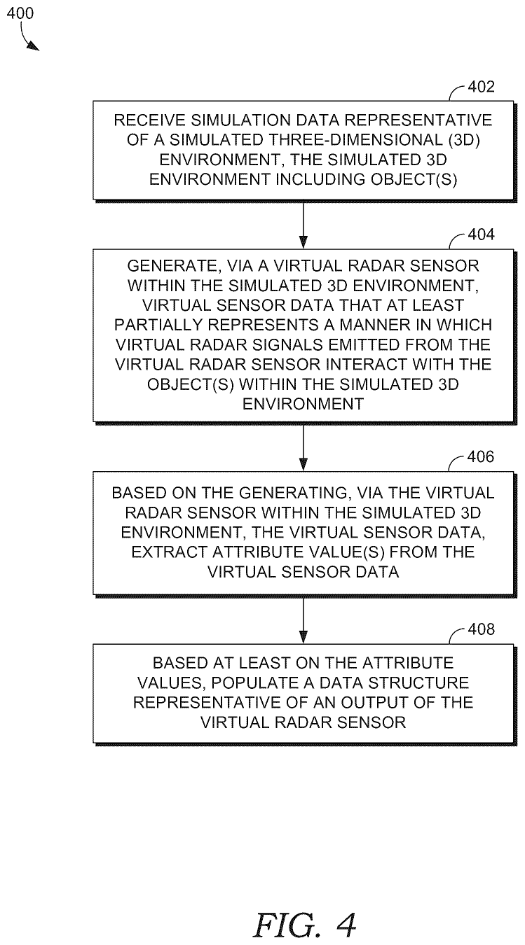

FIG. 4 is a flow diagram of an example method 400 for populating a data structure representative of an output of a virtual radar sensor, according to some embodiments. Each block of method 400 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the process 400 is described, by way of example, with respect to the system 100 of FIG. 1. However, these processes may additionally or alternatively be executed by any one system, or any combination of systems, including, but not limited to, those described herein.

Per block 402, some embodiments receive simulation data representative of a simulated three-dimensional (3D) environment, where the simulated 3D environment includes one or more objects. Examples of the simulation data or simulated 3D environment include the simulated 3D environment 200 or any simulated environment (which does not have to be a 3D environment) generated by the simulation data generator 102.

In some embodiments, the virtual radar sensor is disposed on an exterior surface of a virtual ego machine, where the virtual sensor data represents data that is captured as the virtual ego machine traverses the simulated 3D environment. Examples of this are described with respect to FIG. 2, where, for example, the virtual radar sensor 204 is disposed on an exterior surface of the virtual vehicle 204. It is understood, however, that the virtual radar sensor may be disposed on any suitable surface of any object (e.g., the ground, towers, buildings, etc.) alternative to or in addition to a virtual ego machine.

Per block 404, some embodiments generate, via a virtual radar sensor within the simulated 3D environment, virtual sensor data that at least partially represents a manner in which virtual radar signals (virtual EWs) emitted from the virtual radar sensor interact with the one or more objects within the simulated 3D environment (and/or metadata associated therewith). For example, in some embodiments, the sensor data is indicative of ray tracing that simulates how real-world radar signals (represented by the one or more virtual radar signals) propagate through a real-world environment (represented by the simulated 3D environment) and interact with real-world objects (represented by the one or more objects). Examples of this are described with respect to the virtual EW tracker 106 of FIG. 1 (tracks the “transmitted virtual radar signals” and the “received virtual radar signal(s)”), and the tracking of the primary rays 214 and return rays 212 of FIG. 2. It is understood, however, that ray tracing need not be the only way to indicate the manner in which virtual radar signals interact with the one or more objects. For example, alternative approaches include geometric optics. Various embodiments do not or exclude the use of synthetic signal processing algorithms because of the problems described herein (e.g., increased latency and memory consumption). For example, some embodiments exclude the use of electromagnetic wave propagation models (which calculate FFTs).

In some embodiments, the sensor data is indicative of energy transport simulation by converting a portion of the sensor data to estimated energy of the one or more virtual EWs based on polarization and phase. Polarization refers to the orientation of the electric field vector of an electromagnetic wave. Radar signals can be linearly polarized (where the electric field oscillates in a specific direction) or circularly polarized (where the electric field rotates as the wave propagates). Different materials and surfaces interact with polarized radar waves differently. For example, metallic surfaces tend to reflect radar waves with a certain polarization more effectively than dielectric surfaces. Various embodiments can therefore first estimate polarization based on taking the material ID as input. For example, particular embodiments may generate a database or other data structure (e.g., a lookup table) associates each material ID with its corresponding electromagnetic properties, including parameters relevant to polarization such as dielectric constant, conductivity, and surface roughness. This database can be populated with known material properties obtained from literature, experimental measurements, or simulations.

By analyzing the polarization of the received radar signal compared to the transmitted signal, various embodiments estimate the amount of energy reflected back to the virtual radar receiver. This information helps in determining the radar cross-section (RCS) of targets, which is a measure of their detectability by radar systems. Virtual sensor data can include measurements of received signal polarization, which can be analyzed to estimate the energy of the radar signal returned from targets.

Phase refers to the position of the waveform/virtual radar signal in its cycle. In radar systems, phase information is useful for determining the distance to targets through techniques like pulse timing or phase comparison. By measuring the phase shift between the transmitted and received signals, radar systems can estimate the time delay and hence the distance to the target. Additionally, phase information can be used to analyze the Doppler shift, which provides insights into the relative motion between the radar system and the target. In some embodiments, virtual sensor data includes phase measurements of received virtual radar signals, which can be used to estimate the strength or energy of the reflected signals based on the phase shift and the properties of the radar system. Combining polarization and phase analysis with virtual sensor data allows for a comprehensive understanding of how virtual radar signals interact with targets and the surrounding environment. This understanding enables the estimation of energy distribution in the received signals, which in turn provides valuable insights into target detection, tracking, and characterization.

Per block 406, based on the generating, via the virtual radar sensor within the simulated 3D environment, the virtual sensor data, some embodiments extract one or more attribute values (e.g., ground truth attributes) from the virtual sensor data. Examples of block 406 are described with respect to the ground truth extractor 108. Such attribute values may be included in, for example, the data structures 210 of FIG. 2 or 3310 of FIG. 3.

Some embodiments extract the one or more attribute values at least partially in response to the virtual radar sensor emitting the one or more virtual radar signals. In some embodiments, the one or more attribute values include at least one of: an indication of a location of the one or more objects, a velocity vector of the one or more objects, an identifier of one or more materials of the one or more objects, a behavioral characteristic of the one or more virtual EWs when interacting with the one or more materials, a round trip distance associated with the one or more virtual EWs, and a roundtrip velocity associated with the one or more virtual EWs. Examples of these attribute values are described with respect to the data structure 210 of FIG. 2 and the 310 of FIG. 3.

In some embodiments, the sensor data generated at block 404 includes tracking how the one or more virtual radar signals scatter or reflect in one or more directions upon hitting one or more virtual surfaces of the one or more objects according to a Material Bidirectional Scattering Distribution Function (BSDF). Accordingly, the one or more attribute values are extracted based at least on tracking how the one or more virtual EWs scatter in the one or more directions upon hitting the one or more virtual surfaces of the one or more objects according to the BSDF. For example, some embodiments use a BSDF model to simulate how virtual radar signals scatter upon hitting the virtual surfaces of the objects. Some embodiments then generate scattering patterns that represent the distribution of scattered radar energy in different directions for each surface. Such BSDF characteristics may be represented as the “behavior” attribute as illustrated i the data structure 210 of FIG. 2. Extracting ground truth values may involve measuring parameters such as the amplitude, phase, and polarization of scattered radar signals in various directions. Ground truth values can also include information about the reflectivity, roughness, and other surface properties derived from the BSDF.

Per block 408, based at least in part on the one or more attribute values, some embodiments populate a data structure representative of an output of the virtual radar sensor. Examples of such data structure include the data cube 300 as represented in FIG. 3 or the vector generated by the multidimensional vector generator 110 of FIG. 1. In some embodiments, the data structure represents a vector with a plurality of dimensions, where the plurality of dimensions include two or more of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor. Examples of such vector include the data cube 300 of FIG. 3.

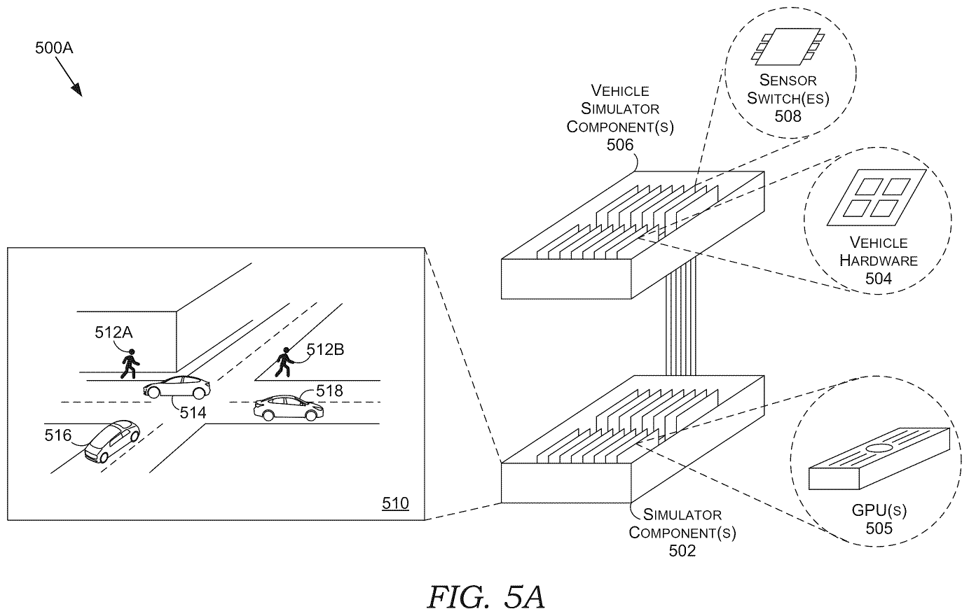

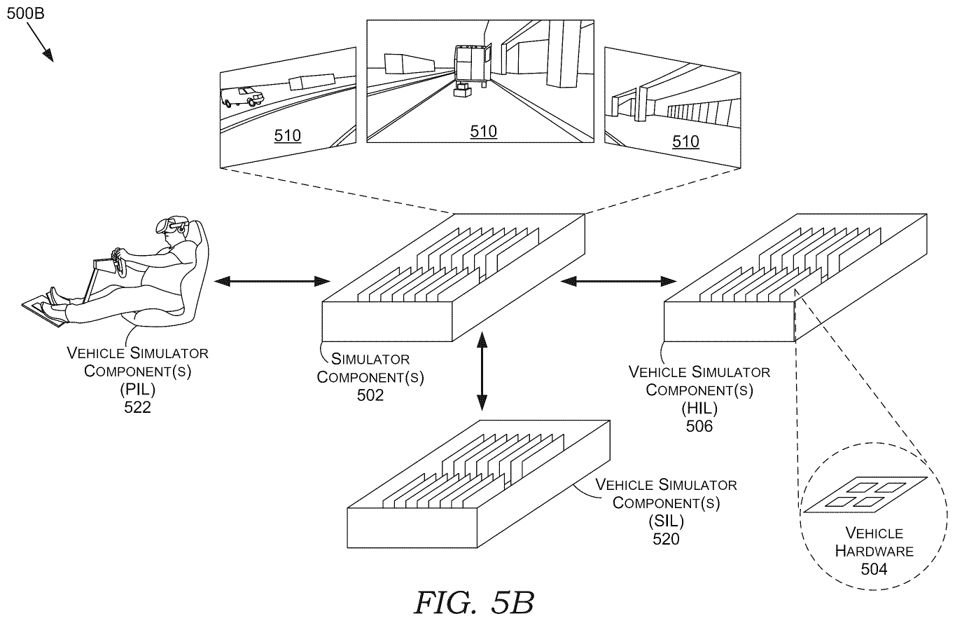

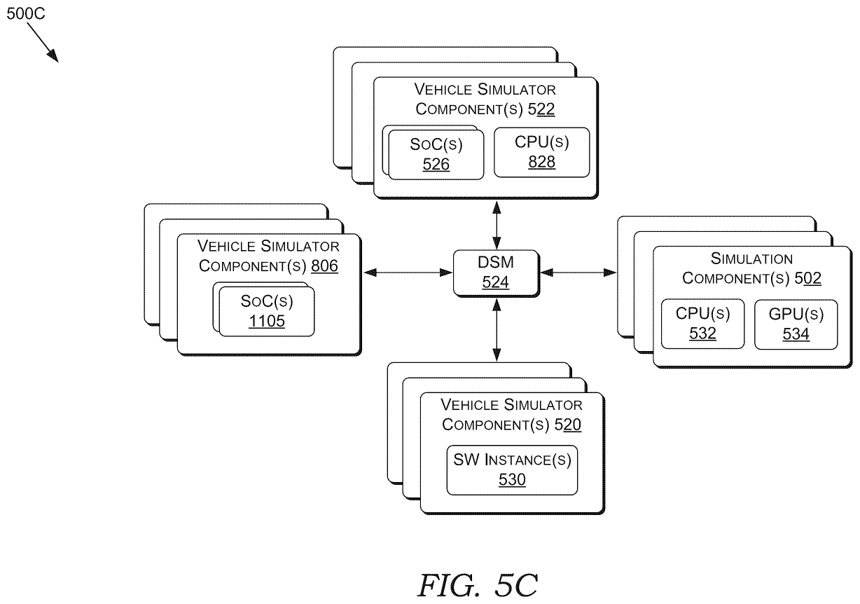

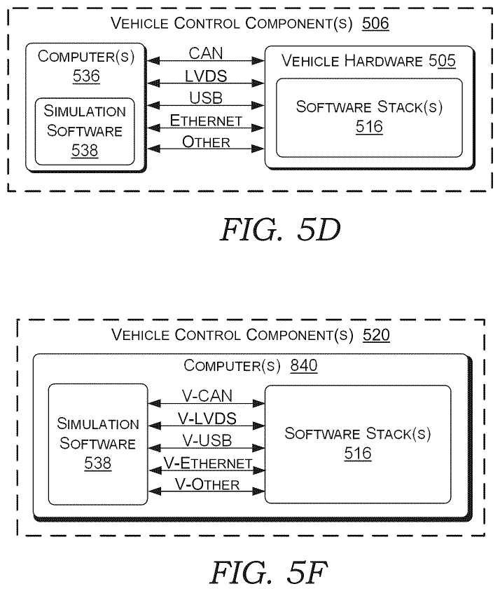

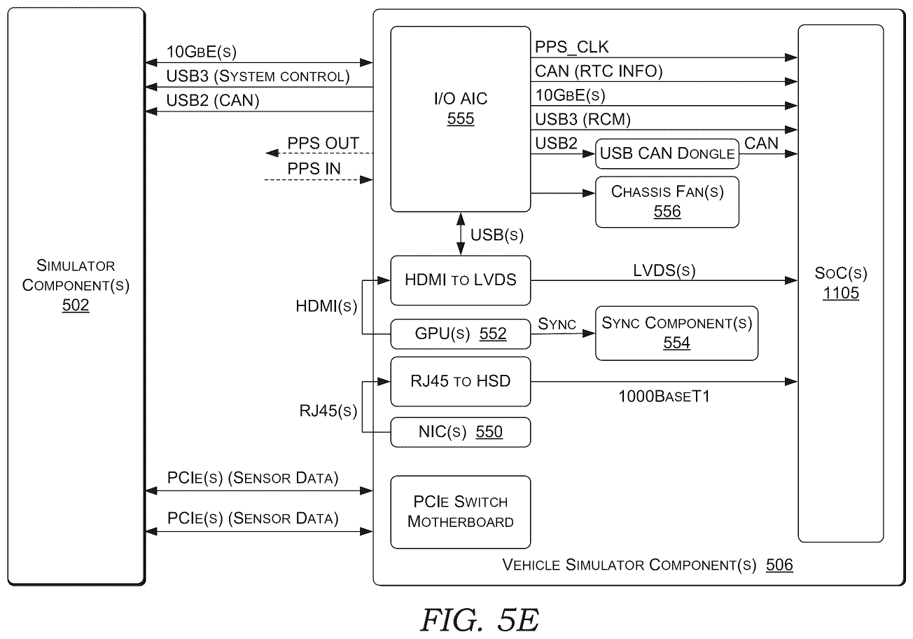

Now referring to FIG. 5A, FIG. 5A is an example illustration of a simulation system 500A, in accordance with some embodiments of the present disclosure. The simulation system 500A may generate a simulated environment 510 that may include AI objects 512 (e.g., AI objects 512A and 512B), HIL objects 514, SIL objects 516, PIL objects 518, and/or other object types. In some embodiments, the simulation system 500A represents functionality included in the simulation data generator 102 of FIG. 1. In some embodiments, the simulated environment 510 represents the output produced by the simulation data generator 102 or represents the simulated 3D environment 200 of FIG. 2. The simulated environment 510 may include features of a driving environment, such as roads, bridges, tunnels, street signs, stop lights, crosswalks, buildings, trees and foliage, the sun, the moon, reflections, shadows, etc., in an effort to simulate a real-world environment accurately within the simulated environment 510. In some examples, the features of the driving environment within the simulated environment 510 may be more true-to-life by including chips, paint, graffiti, wear and tear, damage, etc. Although described with respect to a driving environment, this is not intended to be limiting, and the simulated environment may include an indoor environment (e.g., for a robot, a drone, etc.), an aerial environment (e.g., for a UAV, a drone, an airplane, etc.), an aquatic environment (e.g., for a boat, a ship, a submarine, etc.), and/or another environment type.

The simulated environment 510 may be generated using virtual data, real-world data, or a combination thereof. For example, the simulated environment may include real-world data augmented or changed using virtual data to generate combined data that may be used to simulate certain scenarios or situations with different and/or added elements (e.g., additional AI objects, environmental features, weather conditions, etc.). For example, pre-recorded video may be augmented or changed to include additional pedestrians, obstacles, and/or the like, such that the virtual objects (e.g., executing the software stack(s) as HIL objects and/or SIL objects) may be tested against variations in the real-world data.

The simulated environment may 510 be generated using rasterization, ray-tracing, using DNNs such as generative adversarial networks (GANs), another rendering technique, and/or a combination thereof. For example, in order to create more true-to-life, realistic lighting conditions (e.g., shadows, reflections, glare, global illumination, ambient occlusion, etc.), and the simulation system 500A may use real-time ray-tracing. In one or more embodiments, one or more hardware accelerators may be used by the simulation system 500A to perform real-time ray-tracing. The ray-tracing may be used to simulate LIDAR (and/or radar) sensor for accurate generation of LIDAR data. For example, ray casting may be used in an effort to simulate LIDAR reflectivity. In another example, virtual LIDAR data may be generated using a learned sensor model, as described in more detail above. In any example, ray-tracing techniques used by the simulation system 500A may include one or more techniques described in U.S. Provisional Patent Application No. 62/644,385, filed Mar. 17, 2018, U.S. Provisional Patent Application No. 62/644,386, filed Mar. 17, 2018, U.S. Provisional Patent Application No. 62/644,601, filed Mar. 19, 2018, and U.S. Provisional Application No. 62/644,806, filed Mar. 19, 2018, U.S. Non-Provisional patent application Ser. No. 16/354,983, filed on Mar. 15, 2019, and/or U.S. Non-Provisional patent application Ser. No. 16/355,214, filed on Mar. 15, 2019, each of which is hereby incorporated by reference in its entirety.

In some examples, the simulated environment 510 may be rendered, at least in part, using one or more DNNs, such as generative adversarial neural networks (GANs). For example, real-world data may be collected, such as real-world data captured by autonomous vehicles (e.g., camera(s), LIDAR sensor(s), RADAR sensor(s), etc.), robots, and/or other objects, as well as real-world data that may be captured by any sensors (e.g., images or video pulled from data stores, online resources such as search engines, etc.). The real-world data may then be segmented, classified, and/or categorized, such as by labeling differing portions of the real-world data based on class (e.g., for an image of a landscape, portions of the image—such as pixels or groups of pixels—may be labeled as car, sky, tree, road, building, water, waterfall, vehicle, bus, truck, sedan, etc.). A GAN (or other DNN or machine learning model) may then be trained using the segmented, classified, and/or categorized data to generate new versions of the different types of objects, landscapes, and/or other features as graphics within the simulated environment.

The simulator component(s) 502 of the simulation system 500 may communicate with vehicle simulator component(s) 506 over a wired and/or wireless connection. In some examples, the connection may be a wired connection using one or more sensor switches 808, where the sensor switches may provide low-voltage differential signaling (LVDS) output. For example, the sensor data (e.g., image data) may be transmitted over an HDMI to LVDS connection between the simulator component(s) 502 and the vehicle simulator component(s) 506. The simulator component(s) 502 may include any number of compute nodes (e.g., computers, servers, etc.) interconnected in order to ensure synchronization of the world state. In some examples, as described herein, the communication between each of the compute nodes (e.g., the vehicle simulator component(s) compute nodes and the simulator component(s) compute nodes) may be managed by a distributed shared memory (DSM) system (e.g., DSM 524 of FIG. 5C) using a distributed shared memory protocol (e.g., a coherence protocol). The DSM may include a combination of hardware (cache coherence circuits, network interfaces, etc.) and software. This shared memory architecture may separate memory into shared parts distributed among nodes and main memory, or distributing all memory between all nodes. In some examples, InfiniBand (IB) interfaces and associated communications standards may be used. For example, the communication between and among different nodes of the simulation system 500 (and/or 600) may use IB.

The simulator component(s) 502 may include one or more GPUs 505. The virtual vehicle being simulated may include any number of sensors (e.g., virtual or simulated sensors) that may correspond to one or more of the sensors described herein at least with respect to FIGS. 10A-10C and/or the virtual radar sensor(s) 104 of FIG. 1. Any or all of the sensors of the simulator component(s) 502 may be implemented using a corresponding learned sensor model, as described in more detail above. In some examples, each sensor of the vehicle may correspond to, or be hosted by, one of the GPUs 505. For example, processing for a LIDAR sensor may be executed on a first GPU 505, processing for a wide-view camera may be executed on a second GPU 505, processing for a RADAR sensor may be executed on a third GPU, and so on. As such, the processing of each sensor with respect to the simulated environment may be capable of executing in parallel with each other sensor using a plurality of GPUs 505 to enable real-time simulation. In other examples, two or more sensors may correspond to, or be hosted by, one of the GPUs 505. In such examples, the two or more sensors may be processed by separate threads on the GPU 505 and may be processed in parallel. In other examples, the processing for a single sensor may be distributed across more than one GPU. In addition to, or alternatively from, the GPU(s) 505, one or more TPUs, CPUs, and/or other processor types may be used for processing the sensor data.

Vehicle simulator component(s) 506 may include a compute node of the simulation system 500A that corresponds to a single vehicle represented in the simulated environment 510. Each other vehicle (e.g., 514, 518, 516, etc.) may include a respective node of the simulation system. As a result, the simulation system 500A may be scalable to any number of vehicles or objects as each vehicle or object may be hosted by, or managed by, its own node in the system 500A. In the illustration of FIG. 5A, the vehicle simulator component(s) 506 may correspond to a HIL vehicle (e.g., because the vehicle hardware 504 is used). However, this is not intended to be limiting and, as illustrated in FIGS. 5B and 5C, the simulation system 500 may include SIL vehicles, HIL vehicles, PIL vehicles, and/or AI vehicles. The simulator component(s) 502 (e.g., simulator host device) may include one or more compute nodes of the simulation system 500A, and may host the simulation of the environment with respect to each actor (e.g., with respect to each HIL, SIL, PIL, and AI actors), as well as hosting the rendering and management of the environment or world state (e.g., the road, signs, trees, foliage, sky, sun, lighting, etc.). In some examples, the simulator component(s) 502 may include a server(s) and associated components (e.g., CPU(s), GPU(s), computers, etc.) that may host a simulator (e.g., NVIDIA's DRIVE™ Constellation AV Simulator).

The vehicle hardware 504 may be incorporated into the vehicle simulator component(s) 506. As such, because the vehicle hardware 504 may be configured for installation within the vehicle, the simulation system 500A may be specifically configured to use the vehicle hardware 504 within a node of the simulation system 500A. For example, interfaces used in a physical real-world vehicle may need to be used by the vehicle simulator component(s) 506 to communicate with the vehicle hardware 504. In some examples, the interfaces may include: (1) CAN interfaces, including a PCAN adapter, (2) Ethernet interfaces, including RAW UDP sockets with IP address, origin, VLA, and/or source IP all preserved, (3) Serial interfaces, with a USB to serial adapter, (4) camera interfaces, (5) InfiniBand (IB) interfaces, and/or other interface types.

In any examples, once the sensor data representative of a field(s) of view of the sensor(s) of the vehicle in the simulated environment 510 has been generated and/or processed (e.g., using one or more codecs, as described herein), the sensor data (and/or encoded sensor data) may be used by software stack(s) (e.g., an autonomous driving software stack) executed on the vehicle hardware 504 to perform one or more operations (e.g., generate one or more controls, route planning, detecting objects, identifying drivable free-space, monitoring the environment for obstacle avoidance, etc.). As a result, the identical, or substantially identical, hardware components used by the vehicle (e.g., a physical real-world vehicle) to execute the autonomous driving software stack in real-world environments may be used to execute the autonomous driving software stack in the simulated environment 510. The use of the vehicle hardware 504 in the simulation system 500A thus provides for a more accurate simulation of how the vehicle 502 will perform in real-world situations, scenarios, and environments without having to actually find and test the vehicle in the real-world. This may reduce the amount of driving time required for testing the hardware/software combination used in the physical vehicle and may reduce safety risks by not requiring actual real-world testing (especially for dangerous situations, such as other vehicles driving erratically or at unsafe speeds, children playing in the street, ice on a bridge, etc.).

In addition to the vehicle hardware 504, the vehicle simulator component(s) 506 may manage the simulation of the vehicle (or other object) using additional hardware, such as a computer—e.g., an X86 box. In some examples, additional processing for virtual sensors (e.g., learned sensor models) of the virtual object may be executed using the vehicle simulation component(s) 506. In such examples, at least some of the processing may be performed by the simulator component(s) 502, and other of the processing may be executed by the vehicle simulator component(s) 506 (or 520, or 522, as described herein). In other examples, the processing of the virtual sensors may be executed entirely on the vehicle simulator component(s) 506.

Now referring to FIG. 5B, FIG. 5B is another example illustration of a simulation system 500B, in accordance with some embodiments of the present disclosure. The simulation system 500B may include the simulator component(s) 502 (as one or more compute nodes), the vehicle simulator component(s) 506 (as one or more compute nodes) for a HIL object(s), the vehicle simulator component(s) 520 (as one or more compute nodes) for a SIL object(s), the vehicle simulator component(s) 506 (as one or more compute nodes) for a PIL object(s), and/or additional component(s) (or compute nodes) for AI objects and/or other object types. Each of the PIL, HIL, SIL, AI, and/or other object type compute nodes may communicate with the simulator component(s) 502 to capture from the global simulation at least data that corresponds to the respective object within the simulate environment 510.

For example, the vehicle simulator component(s) 522 may receive (e.g., retrieve, obtain, etc.), from the global simulation (e.g., represented by the simulated environment 510) hosted by the simulator component(s) 502, data that corresponds to, is associated with, and/or is required by the vehicle simulator component(s) 522 to perform one or more operations by the vehicle simulator component(s) 522 for the PIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the PIL object may be received from the simulator component(s) 502. This data may be used to generate an instance of the simulated environment corresponding to the field of view of a remote operator of the virtual vehicle controlled by the remote operator, and the portion of the simulated environment may be projected on a display (e.g., a display of a VR headset, a computer or television display, etc.) for assisting the remote operator in controlling the virtual vehicle through the simulated environment 510. The controls generated or input by the remote operator using the vehicle simulator component(s) 522 may be transmitted to the simulator component(s) 502 for updating a state of the virtual vehicle within the simulated environment 510.

As another example, the vehicle simulator component(s) 520 may receive (e.g., retrieve, obtain, etc.), from the global simulation hosted by the simulator component(s) 502, data that corresponds to, is associated with, and/or is required by the vehicle simulator component(s) 520 to perform one or more operations by the vehicle simulator component(s) 520 for the SIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the SIL object may be received from the simulator component(s) 802. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 520. In some examples, the sensor data may be encoded using one or more codecs (e.g., each sensor may use its own codec, or each sensor type may use its own codec) in order to generate encoded sensor data that may be understood or familiar to an autonomous driving software stack simulated or emulated by the vehicle simulator component(s) 520. For example, a first vehicle manufacturer may use a first type of LIDAR data, a second vehicle manufacturer may use a second type of LIDAR data, etc., and thus the codecs may customize the sensor data to the types of sensor data used by the manufacturers. As a result, the simulation system 500 may be universal, customizable, and/or useable by any number of different sensor types depending on the types of sensors and the corresponding data types used by different manufacturers. In any example, the sensor data and/or encoded sensor data may be used by an autonomous driving software stack to perform one or more operations (e.g., object detection, path planning, control determinations, actuation types, etc.). For example, the sensor data and/or encoded data may be used as inputs to one or more DNNs of the autonomous driving software stack, and the outputs of the one or more DNNs may be used for updating a state of the virtual vehicle within the simulated environment 510. As such, the reliability and efficacy of the autonomous driving software stack, including one or more DNNs, may be tested, fine-tuned, verified, and/or validated within the simulated environment.

In yet another example, the vehicle simulator component(s) 506 may receive (e.g., retrieve, obtain, etc.), from the global simulation hosted by the simulator component(s) 502, data that corresponds to, is associated with, and/or is required by the vehicle simulator component(s) 806 to perform one or more operations by the vehicle simulator component(s) 506 for the HIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the HIL object may be received from the simulator component(s) 502. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 520 (e.g., using a corresponding learned sensor model). In some examples, the sensor data may be encoded using one or more codecs (e.g., each sensor may use its own codec, or each sensor type may use its own codec) in order to generate encoded sensor data that may be understood or familiar to an autonomous driving software stack executing on the vehicle hardware of the vehicle simulator component(s) 520. Similar to the SIL object described herein, the sensor data and/or encoded sensor data may be used by an autonomous driving software stack to perform one or more operations (e.g., object detection, path planning, control determinations, actuation types, etc.).

Now referring to FIG. 5C, FIG. 5C is another example illustration of a simulation system 500C, in accordance with some embodiments of the present disclosure. The simulation system 500C may include distributed shared memory (DSM) system 524, the simulator component(s) 502 (as one or more compute nodes), the vehicle simulator component(s) 506 (as one or more compute nodes) for a HIL object(s), the vehicle simulator component(s) 520 (as one or more compute nodes) for a SIL object(s), the vehicle simulator component(s) 506 (as one or more compute nodes) for a PIL object(s), and/or additional component(s) (or compute nodes) for AI objects and/or other object types (not shown). The simulation system 500C may include any number of HIL objects (e.g., each including its own vehicle simulator component(s) 506), any number of SIL objects (e.g., each including its own vehicle simulator component(s) 520), any number of PIL objects (e.g., each including its own vehicle simulator component(s) 522), and/or any number of AI objects (not shown, but may be hosted by the simulation component(s) 502 and/or separate compute nodes, depending on the embodiment).

The vehicle simulator component(s) 506 may include one or more SoC(s) 1105 (or other components) that may be configured for installation and use within a physical vehicle. As such, as described herein, the simulation system 500C may be configured to use the SoC(s) 1105 and/or other vehicle hardware 504 by using specific interfaces for communicating with the SoC(s) 1105 and/or other vehicle hardware. The vehicle simulator component(s) 520 may include one or more software instances 530 that may be hosted on one or more GPUs and/or CPUs to simulate or emulate the SoC(s) 1105. The vehicle simulator component(s) 522 may include one or more SoC(s) 526, one or more CPU(s) 528 (e.g., X86 boxes), and/or a combination thereof, in addition to the component(s) that may be used by the remote operator (e.g., keyboard, mouse, joystick, monitors, VR systems, steering wheel, pedals, in-vehicle components, such as light switches, blinkers, HMI display(s), etc., and/or other component(s)).

The simulation component(s) 502 may include any number of CPU(s) 532 (e.g., X86 boxes), GPU(s), and/or a combination thereof. The CPU(s) 532 may host the simulation software for maintaining the global simulation, and the GPU(s) 534 may be used for rendering, physics, and/or other functionality for generating the simulated environment 510.

As described herein, the simulation system 500C may include the DSM 524. The DSM 524 may use one or more distributed shared memory protocols to maintain the state of the global simulation using the state of each of the objects (e.g., HIL objects, SIL objects, PIL objects, AI objects, etc.). As such, each of the compute nodes corresponding to the vehicle simulator component(s) 506, 520, and/or 522 may be in communication with the simulation component(s) 502 via the DSM 524. By using the DSM 524 and the associated protocols, real-time simulation may be possible. For example, as opposed to how network protocols (e.g., TCP, UDP, etc.) are used in massive multiplayer online (MMO) games, the simulation system 500 may use a distributed shared memory protocol to maintain the state of the global simulation and each instance of the simulation (e.g., by each vehicle, object, and/or sensor) in real-time.

Now referring to FIG. 5D, FIG. 5D is an example illustration of a hardware-in-the-loop configuration, in accordance with some embodiments of the present disclosure. The vehicle simulator component(s) 506 may include the vehicle hardware 504, as described herein, and may include one or more computer(s) 536, one or more GPU(s) (not shown), and/or one or more CPU(s) (not shown). The computer(s) 536, GPU(s), and/or CPU(s) may manage or host the simulation software 538, or instance thereof, executing on the vehicle simulator component(s) 506. The vehicle hardware 504 may execute the software stack(s) 516 (e.g., an autonomous driving software stack, an IX software stack, etc.).

As described herein, by using the vehicle hardware 504, the other vehicle simulator component(s) 506 within the simulation environment 500 may need to be configured for communication with the vehicle hardware 504. For example, because the vehicle hardware 504 may be configured for installation within a physical vehicle, the vehicle hardware 504 may be configured to communicate over one or more connection types and/or communication protocols that are not standard in computing environments (e.g., in server-based platforms, in general-purpose computers, etc.). For example, a CAN interface, LVDS interface, USB interface, Ethernet interface, InfiniBand (IB) interface, and/or other interfaces may be used by the vehicle hardware 504 to communicate signals with other components of the physical vehicle. As such, in the simulation system 500, the vehicle simulator component(s) 506 (and/or other component(s) of the simulation system 500 in addition to, or alternative from, the vehicle simulator component(s) 506) may need to be configured for use with the vehicle hardware 504. In order to accomplish this, one or more CAN interfaces, LVDS interfaces, USB interfaces, Ethernet interfaces, and/or other interface may be used to provide for communication (e.g., over one or more communication protocols, such as LVDS) between vehicle hardware 504 and the other component(s) of the simulation system 500.

In some examples, the virtual vehicle that may correspond to the vehicle simulator component(s) 506 within the simulation system 500 may be modeled as a game object within an instance of a game engine. In addition, each of the virtual sensors of the virtual vehicle may be interfaced using sockets within the virtual vehicle's software stack(s) 516 executed on the vehicle hardware 504. In some examples, each of the virtual sensors of the virtual vehicle may include an instance of the game engine, in addition to the instance of the game engine associated with the simulation software 538 for the virtual vehicle. In examples where the vehicle simulator component(s) 506 include a plurality of GPUs, each of the sensors may be executed on a single GPU. In other examples, multiple sensors may be executed on a single GPU, or at least as many sensors as feasible to ensure real-time generation of the virtual sensor data.

Using HIL objects in the simulator system 500 may provide for a scalable solution that may simulate or emulate various driving conditions for autonomous software and hardware systems (e.g., NVIDIA's DRIVE AGX Pegasus™ compute platform and/or DRIVE PX Xavier™ compute platform). Some benefits of HIL objects may include the ability to test DNNs faster than real-time, the ability to scale verification with computing resources (e.g., rather than vehicles or test tracks), the ability to perform deterministic regression testing (e.g., the real-world environment is never the same twice, but a simulated environment can be), optimal ground truth labeling (e.g., no hand-labeling required), the ability to test scenarios difficult to produce in the real-world, rapid generation of test permutations, and the ability to test a larger space of permutations in simulation as compared to real-world.

Now referring to FIG. 5E, FIG. 5E is an example illustration of a hardware-in-the-loop configuration, in accordance with some embodiments of the present disclosure. The HIL configuration of FIG. 5 may include vehicle simulator component(s) 506, including the SoC(s) 1105, a chassis fan(s) 556 and/or water-cooling system. The HIL configuration may include a two-box solution (e.g., the simulator component(s) 502 in a first box and the vehicle simulator component(s) 506 in a second box). Using this approach may reduce the amount of space the system occupies as well as reduce the number of external cables in data centers (e.g., by including multiple components together with the SoC(s) 1105 in the vehicle simulator component(s) 506—e.g., the first box). The vehicle simulator component(s) 506 may include one or more GPUs 552 (e.g., NVIDIA QUADRO GPU(s)) that may provide, in an example, non-limiting embodiment, 8 DP/HDMI video streams that may be synchronized using sync component(s) 554 (e.g., through a QUADRO Sync II Card). These GPU(s) 552 (and/or other GPU types) may provide the sensor input to the SoC(s) 1105 (e.g., to the vehicle hardware 504). In some examples, the vehicle simulator component(s) 506 may include a network interface (e.g., one or more network interface cards (NICs) 550) that may simulate or emulate RADAR sensors, LIDAR sensors, and/or IMU sensors (e.g., by providing 8 Gigabit ports with precision time protocol (PTP) support). In addition, the vehicle simulator component(s) 506 may include an input/output (I/O) analog integrated circuit 555. Registered Jack (RJ) interfaces (e.g., RJ45), high speed data (HSD) interfaces, USB interfaces, pulse per second (PPS) clocks, Ethernet (e.g., 10 Gb Ethernet (GbE)) interfaces, CAN interfaces, HDMI interfaces, and/or other interface types may be used to effectively transmit and communication data between and among the various component(s) of the system.

Now referring to FIG. 5F, FIG. 5F is an example illustration of a software-in-the-loop configuration, in accordance with some embodiments of the present disclosure. The vehicle simulator component(s) 520 may include computer(s) 550, GPU(s) (not shown), CPU(s) (not shown), and/or other components. The computer(s) 540, GPU(s), and/or CPU(s) may manage or host the simulation software 538, or instance thereof, executing on the vehicle simulator component(s) 520, and may host the software stack(s) 516. For example, the vehicle simulator component(s) 520 may simulate or emulate, using software, the vehicle hardware 504 in an effort to execute the software stack(s) 516 as accurately as possible.

In order to increase accuracy in SIL embodiments, the vehicle simulator component(s) 520 may be configured to communicate over one or more virtual connection types and/or communication protocols that are not standard in computing environments. For example, a virtual CAN interface, virtual LVDS interface, virtual USB interface, virtual Ethernet interface, and/or other virtual interfaces may be used by the computer(s) 540, CPU(s), and/or GPU(s) of the vehicle simulator component(s) 520 to provide for communication (e.g., over one or more communication protocols, such as LVDS) between the software stack(s) 516 and the simulation software 538 within the simulation system 500. For example, the virtual interfaces may include middleware that may be used to provide a continuous feedback loop with the software stack(s) 516. As such, the virtual interfaces may simulate or emulate the communications between the vehicle hardware 504 and the physical vehicle using one or more software protocols, hardware (e.g., CPU(s), GPU(s), computer(s) 540, etc.), or a combination thereof.

The computer(s) 540 in some examples, may include X86 CPU hardware, and one or more X86 CPUs may execute both the simulation software 538 and the software stack(s) 516. In other examples, the computer(s) 540 may include GPU hardware (e.g., an NVIDIA DGX system and/or cloud-based NVIDIA Tesla servers).

In some examples, the virtual vehicle that may correspond to the vehicle simulator component(s) 520 within the simulation system 500 may be modeled as a game object within an instance of a game engine. In addition, each of the virtual sensors of the virtual vehicle may be interfaced using sockets within the virtual vehicle's software stack(s) 516 executed on the vehicle simulator component(s) 520. In some examples, each of the virtual sensors of the virtual vehicle may include an instance of the game engine, in addition to the instance of the game engine associated with the simulation software 538 for the virtual vehicle. In examples where the vehicle simulator component(s) 506 include a plurality of GPUs, each of the sensors may be executed on a single GPU. In other examples, multiple sensors may be executed on a single GPU, or at least as many sensors as feasible to ensure real-time generation of the virtual sensor data.

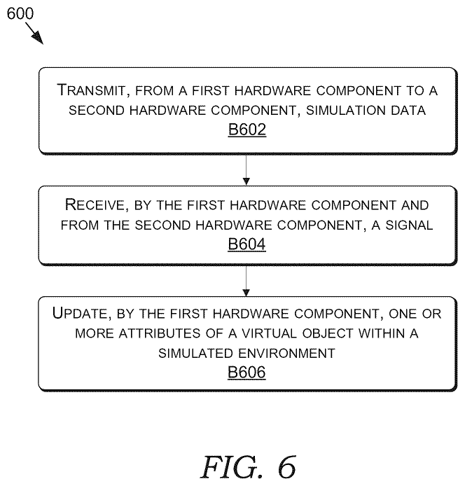

Now referring to FIG. 6, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the simulation system 500 of FIGS. 5A-5C. However, the method may additionally or alternatively be executed by any one system, or any combination of systems, including, but not limited to, those described herein.

FIG. 6 is a flow diagram showing a method 600 for generating a simulated environment using a hardware-in-the-loop object, in accordance with some embodiments of the present disclosure. The method 600, at block B602, includes transmitting, from a first hardware component to a second hardware component, simulation data. For example, simulation component(s) 602 may transmit simulation data to one or more of the vehicle simulator component(s) 606, the vehicle simulator component(s) 620, and/or the vehicle simulator component(s) 622. In some examples, the simulation data may be representative of at least a portion of the simulated environment 510 hosted by the simulation component(s) 502, and may correspond to the simulated environment 510 with respect to at least one virtual sensor (e.g., implemented using a learned sensor model) of a virtual object (e.g., a HIL object, a SIL object, a PIL object, and/or an AI object). In an example where the virtual sensor is a virtual camera, the simulation data may correspond to at least the data from the simulation necessary to generate a field of view of the virtual camera within the simulated environment 810.

The method 600, at block B604, includes receiving a signal by the first hardware component and from the second hardware component. For example, the simulator component(s) 502 may receive a signal from one of the vehicle simulator component(s) 506, the vehicle simulator component(s) 520, and/or the vehicle simulator component(s) 522. The signal may be representative of an operation (e.g., control, path planning, object detection, etc.) corresponding to a virtual object (e.g., a HIL object, a SIL object, a PIL object, and/or an AI object) as determined by a software stack(s) 516 (e.g., based at least in part on the virtual sensor data). In some examples, such as where the virtual object is a HIL object, the signal (or data represented thereby) may be transmitted from the vehicle hardware 504 to one or more other vehicle simulator component(s) 506, and then the vehicle simulator component(s) 506 may transmit the signal to the simulator component(s) 502. In such examples, the signals between the vehicle simulator component(s) 506 (e.g., between the vehicle hardware 504 and one or more GPU(s), CPU(s), and/or computer(s) 536) may be transmitted via a CAN interface, a USB interface, an LVDS interface, an Ethernet interface, and/or another interface. In another example, such as where the virtual object is a SIL object, the signal (or data represented thereby) may be transmitted from the vehicle simulator component(s) 520 to the simulator component(s) 502, where the data included in the signal may be generated by the software stack(s) 516 executing on simulated or emulated vehicle hardware 804. In such examples, the vehicle simulator component(s) 520 may use a virtual CAN, a virtual LVDS interface, a virtual USB interface, a virtual Ethernet interface, and/or other virtual interfaces.

The method 600, at block B606, includes updating, by the first hardware component, one or more attributes of a virtual object within a simulated environment. For example, based at least in part on the signal received from the vehicle simulator component(s) 506, the vehicle simulator component(s) 520, and/or the vehicle simulator component(s) 522, the simulator component(s) 502 may update the global simulation (and the simulated environment may be updated accordingly). In some examples, the data represented by the signal may be used to update a location, orientation, speed, and/or other attributes of the virtual object hosted by the vehicle simulator component(s) 506, the vehicle simulator component(s) 520, and/or the vehicle simulator component(s) 522.

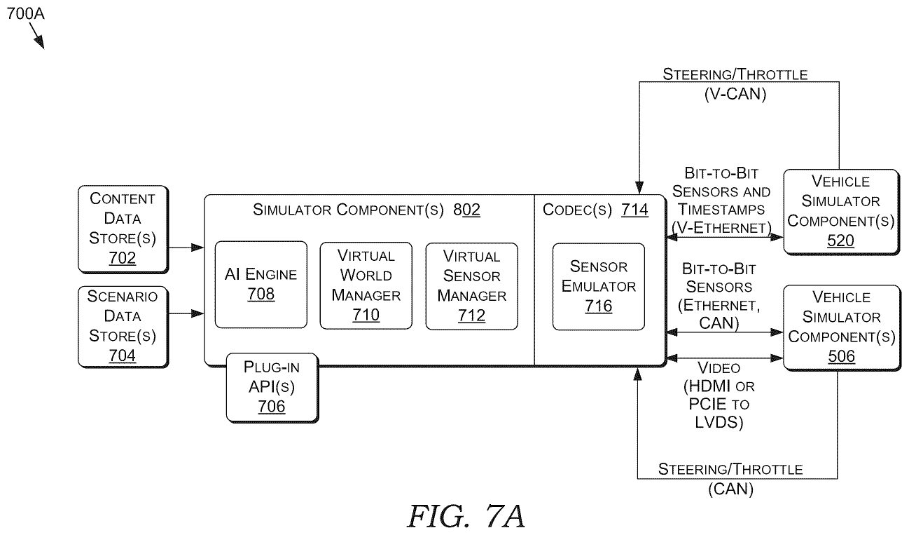

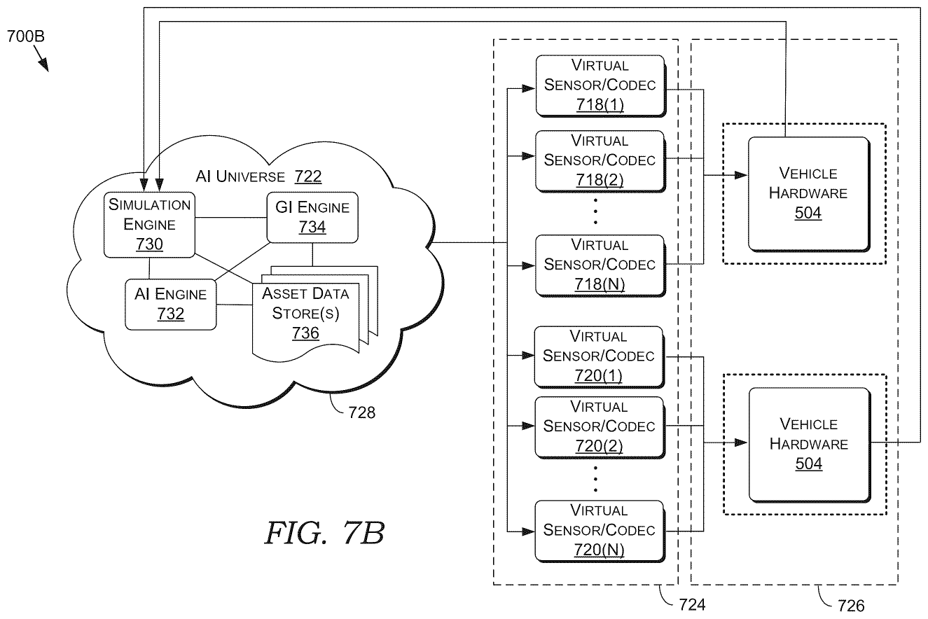

Now referring to FIG. 7A, FIG. 7A is an example illustration of a simulation system 700 at runtime, in accordance with some embodiments of the present disclosure. Some or all of the components of the simulation system 700 may be used in the simulation system 500, and some or all of the components of the simulation system 500 may be used in the simulation system 500 (e.g., to produce the simulation environment 510). As such, components, features, and/or functionality described with respect to the simulation system 500 may be associated with the simulation system 700, and vice versa. In addition, each of the simulation systems 700A and 700B (FIG. 7B) may include similar and/or shared components, features, and/or functionality.

The simulation system 700A (e.g., representing one example of simulation system 700) may include the simulator component(s) 502, codec(s) 1714, content data store(s) 702, scenario data store(s) 704, vehicle simulator component(s) 520 (e.g., for a SIL object), and vehicle simulator component(s) 506 (e.g., for a HIL object). The content data store(s) 702 may include detailed content information for modeling cars, trucks, people, bicyclists, signs, buildings, trees, curbs, and/or other features of the simulated environment. The scenario data store(s) 704 may include scenario information that may include dangerous scenario information (e.g., that is unsafe to test in the real-world environment), such as a child in an intersection.

The simulator component(s) 502 may include an AI engine 708 that simulates traffic, pedestrians, weather, and/or other AI features of the simulated environment. The simulator component(s) 702 may include a virtual world manager 710 that manages the world state for the global simulation. The simulator component(s) 502 may further include a virtual sensor manger 712 that may mange the virtual sensors (any or all of which may be implemented using a corresponding learned sensor model). The AI engine 708 may model traffic similar to how traffic is modeled in an automotive video game, and may be done using a game engine, as described herein. In other examples, custom AI may be used to provide the determinism and computational level of detail necessary for large-scale reproducible automotive simulation. In some examples, traffic may be modeled using SIL objects, HIL objects, PIL objects, AI objects, and/or combination thereof. The system 700 may create a subclass of an AI controller that examines map data, computes a route, and drives the route while avoiding other cars. The AI controller may compute desired steering, acceleration, and/or braking, and may apply those values to the virtual objects. The vehicle properties used may include mass, max RPM, torque curves, and/or other properties. A physics engine may be used to determine states of AI objects. As described herein, for vehicles or other objects that may be far away and may not have an impact on a current sensor(s), the system may choose not to apply physics for those objects and only determine locations and/or instantaneous motion vectors. Ray-casting may be used for each wheel to ensure that the wheels of the vehicles are in contact. In some examples, traffic AI may operate according to a script (e.g., rules-based traffic). Traffic AI maneuvers for virtual objects may include lateral lane changes (e.g., direction, distance, duration, shape, etc.), longitudinal movement (e.g., matching speed, relative target, delta to target, absolute value), route following, and/or path following. The triggers for the traffic AI maneuvers may be time-based (e.g., three seconds), velocity-based (e.g., at sixty mph), proximity-based to map (e.g., within twenty feet of intersection), proximity-based to actor (e.g., within twenty feet of another object), lane clear, and/or others.

The AI engine 708 may model pedestrian AI similar to traffic AI, described herein, but for pedestrians. The pedestrians may be modeled similar to real pedestrians, and the system 1000 may infer pedestrian conduct based on learned behaviors.

The simulator component(s) 502 may be used to adjust the time of day such that street lights turn on and off, headlights turn on and off, shadows, glares, and/or sunsets are considered, etc. In some examples, only lights within a threshold distance to the virtual object may be considered to increase efficiency.

Weather may be accounted for by the simulator component(s) 502 (e.g., by the virtual world manager 710). The weather may be used to update the coefficients of friction for the driving surfaces, and temperature information may be used to update tire interaction with the driving surfaces. Where rain or snow are present, the system 700 may generate meshes to describe where rainwater and snow may accumulate based on the structure of the scene, and the meshes may be employed when rain or snow are present in the simulation.

In some examples, as described herein, at least some of the simulator component(s) 502 may alternatively be included in the vehicle simulator component(s) 520 and/or 506. For example, the vehicle simulator component(s) 520 and/or the vehicle simulator component(s) 506 may include the virtual sensor manager 712 for managing each of the sensors of the associated virtual object. In addition, one or more of the codecs 714 may be included in the vehicle simulator component(s) 520 and/or the vehicle simulator component(s) 506. In such examples, the virtual sensor manager 712 may generate sensor data corresponding to a sensor of the virtual object (e.g., using a learned sensor model), and the sensor data may be used by sensor emulator 716 of the codec(s) 714 to encode the sensor data according to the sensor data format or type used by the software stack(s) 516 (e.g., the software stack(s) 516 executing on the vehicle simulator component(s) 520 and/or the vehicle simulator component(s) 506).

The codec(s) 714 may provide an interface to the software stack(s) 516. The codec(s) 714 (and/or other codec(s) described herein) may include an encoder/decoder framework. The codec(s) 714 may include CAN steering, throttle requests, and/or may be used to send sensor data to the software stack(s) 516 in SIL and HIL embodiments. The codec(s) 714 may be beneficial to the simulation systems described herein (e.g., 500 and 700). For example, as data is produced by the simulation systems 500 and 700, the data may be transmitted to the software stack(s) 516 such that the following standards may be met. The data may be transferred to the software stack(s) 516 such that minimal impact is introduced to the software stack(s) 516 and/or the vehicle hardware 504 (in HIL embodiments). This may result in more accurate simulations as the software stack(s) 516 and/or the vehicle hardware 504 may be operating in an environment that closely resembles deployment in a real-world environment. The data may be transmitted to the software stack(s) 516 such that the simulator and/or re-simulator may be agnostic to the actual hardware configuration of the system under test. This may reduce development overhead due to bugs or separate code paths depending on the simulation configuration. The data may be transmitted to the software stack(s) 516 such that the data may match (e.g., bit-to-bit) the data sent from a physical sensor of a physical real-world vehicle. The data may be transmitted to efficiently in both SIL and HIL embodiments.

The sensor emulator 716 may emulate at least cameras, LIDAR sensors, and/or RADAR sensors, any or all of which may be implemented using a corresponding learned sensor model. Using a learned sensor model may obviate the need to model the sensor using ray-tracing, although in some embodiments, ray-tracing may additionally or alternatively be used. With respect to LIDAR sensors, some LIDAR sensors report tracked objects. As such, for each frame represented by the virtual sensor data, the simulator component(s) 502 may create a list of all tracked objects (e.g., trees, vehicles, pedestrians, foliage, etc.) within range of the virtual object having the virtual LIDAR sensors, and may cast virtual rays toward the tracked objects. When a significant number of rays strike a tracked object, that object may be added to the report of the LIDAR data. In some examples, the LIDAR sensors may be modeled using simple ray-casting without reflection, adjustable field of view, adjustable noise, and/or adjustable drop-outs. LIDAR with moving parts, limited fields of view, and/or variable resolutions may be simulated. For example, the LIDAR sensors may be modeled as solid state LIDAR and/or as Optix-based LIDAR. In examples, using Optix-based LIDAR, the rays may bounce from water, reflective materials, and/or windows. Texture may be assigned to roads, signs, and/or vehicles to model laser reflection at the wavelengths corresponding to the textures. RADAR may be implemented similarly to LIDAR. As described herein, RADAR and/or LIDAR may be simulated using learned sensors, ray-tracing techniques, and/or otherwise.

In some examples, the vehicle simulator component(s) 506, 520, and/or 522 may include a feedback loop with the simulator component(s) 502 (and/or the component(s) that generate the virtual sensor data). The feedback loop may be used to provide information for updating the virtual sensor data capture or generation. For example, for virtual cameras, the feedback loop may be based on sensor feedback, such as changes to exposure responsive to lighting conditions (e.g., increase exposure in dim lighting conditions so that the image data may be processed by the DNNs properly). As another example, for virtual LIDAR sensors, the feedback loop may be representative of changes to energy level (e.g., to boost energy to produce more useable or accurate LIDAR data).

GNNS sensors (e.g., GPS sensors) may be simulated within the simulation space to generate real-world coordinates. In order to this, noise functions may be used to approximate inaccuracy. As with any virtual sensors described herein, the virtual sensor data may be generated using a learned sensor model or otherwise, and transmitted to the software stack(s) 516 using the codec(s) 714 to be converted to a bit-to-bit correct signal (e.g., corresponding accurately to the signals generated by the physical sensors of the physical vehicles).

One or more plugin application programming interfaces (APIs) 706 may be used. The plugin APIs 706 may include first-party and/or third-party plugins. For example, third parties may customize the simulation system 700B using their own plugin APIs 706 for providing custom information, such as performance timings, suspension dynamics, tire dynamics, etc.

The plugin APIs 706 may include an ego-dynamics component(s) (not shown) that may receive information from the simulator component(s) 502 including position, velocity, car state, and/or other information, and may provide information to the simulator component(s) 502 including performance timings, suspension dynamics, tire dynamics, and/or other information. For examples, the simulator component(s) 502 may provide CAN throttle, steering, and the driving surface information to the ego-dynamics component(s). In some examples, the ego-dynamics component(s) may include an off-the-shelf vehicle dynamics package (e.g., IPG CARMAKER or VIRTUAL TEST DRIVE), while in other examples the ego-dynamics component(s) may be customized and/or received (e.g., from a first-party and/or a third-party).

The plugin APIs 706 may include a key performance indicator (KPI) API. The KPI API may receive CAN data, ground truth, and/or virtual object state information (e.g., from the software stack(s) 516) from the simulator component(s) 502 and may generate and/or provide a report (in real-time) that includes KPI's and/or commands to save state, restore state, and/or apply changes.

Now referring to FIG. 7B, FIG. 17B includes a cloud-based architecture for a simulation system 700B, in accordance with some embodiment of the present disclosure. The simulation system 700B may, at least partly, reside in the cloud and may communicate over one or more networks, such as but not limited to those described herein, with one or more GPU platforms 724 (e.g., that may include GPUs, CPUs, TPUS, and/or other processor types) and/or one or more HIL platforms 726 (e.g., which may include some or all of the components from the vehicle simulator component(s) 506, described herein).

A simulated environment 728 (e.g., which may be similar to the simulated environment 510 described herein) may be modeled by interconnected components including a simulation engine 730, an AI engine 732, a global illumination (GI) engine 734, an asset data store(s) 736, and/or other components. In some examples, these component(s) may be used to model a simulated environment (e.g., a virtual world) in a virtualized interactive platform (e.g., similar to a massive multiplayer online (MMO) game environment. The simulated environment may further include physics, traffic simulation, weather simulation, and/or other features and simulations for the simulated environment. GI engine 734 may calculate GI once and share the calculation with each of the nodes 718(1)-718(N) and 720(1)-720(N) (e.g., the calculation of GI may be view independent). The simulated environment 728 may include an AI universe 722 that provides data to GPU platforms 724 (e.g., GPU servers) that may create renderings for each sensor of the vehicle (e.g., at the virtual sensor/codec(s) 718 for a first virtual object and at the virtual sensor codec(s) 720 for a second virtual object). For example, the GPU platform 724 may receive data about the simulated environment 728 and may create sensor inputs for each of 718(1)-718(N), 720(1)-720(N), and/or virtual sensor/codec pairs corresponding to other virtual objects (depending on the embodiment). In examples where the virtual objects are simulated using HIL objects, the sensor inputs may be provided to the vehicle hardware 504 which may use the software stack(s) 516 to perform one or more operations and/or generate one or more commands, such as those described herein. In some examples, as described herein, the virtual sensor data from each of the virtual sensors may be encoded using a codec prior to being used by (or transmitted to) the software stack(s) 516. In addition, in some examples, each of the sensors may be executed on its own GPU within the GPU platform 724, while in other examples, two or more sensors may share the same GPU within the GPU platform 724.

The one or more operations or commands may be transmitted to the simulation engine 730 which may update the behavior of one or more of the virtual objects based on the operations and/or commands. For example, the simulation engine 730 may use the AI engine 732 to update the behavior of the AI agents as well as the virtual objects in the simulated environment 728. The simulation engine 730 may then update the object data and characteristics (e.g., within the asset data store(s) 736), may update the GI (and/or other aspects such as reflections, shadows, etc.), and then may generate and provide updated sensor inputs to the GPU platform 724. This process may repeat until a simulation is completed.

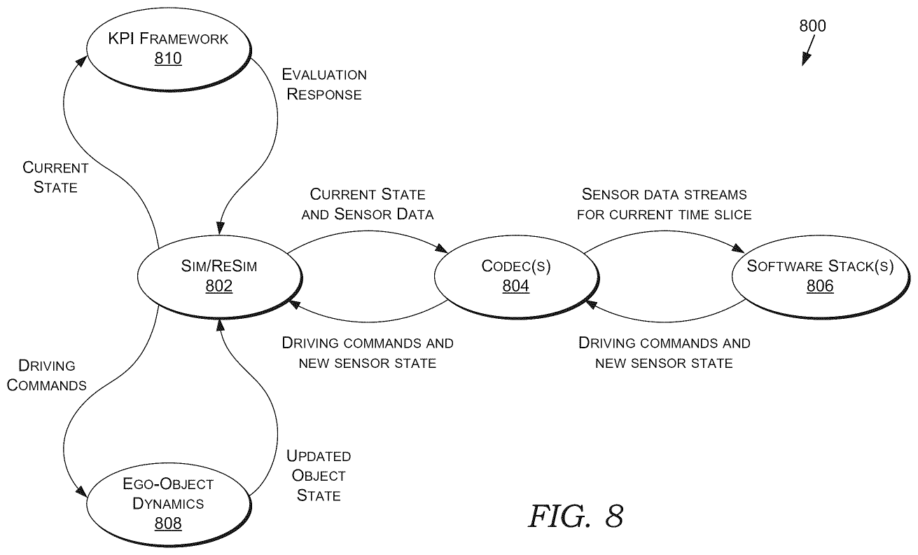

Now referring to FIG. 8, FIG. 8 includes a data flow diagram illustrating a process 800 for re-simulation or simulation using one or more codecs, in accordance with some embodiments of the present disclosure. The process 800 may include a current state and/or sensor data be transmitted from the simulation and/or re-simulation to one or more codecs 804. At least some of the data (e.g., the sensor data) may then be encoded using the codec(s) 804 and provided to the software stack(s) 806 (e.g., similar to the software stack(s) 516) for a current time slice. The driving commands and new sensor state may then transmitted (e.g., via CAN or V-CAN) to the codec(s) 804 and back to the simulation and/or re-simulation. The driving commands generated originally by the software stack(s) 806 (e.g., by an autonomous driving software stack) may then be passed to ego-object dynamics which may use custom or built-in dynamics to update the object state for the particular type of virtual object being simulated and the updated object state may be passed back to the simulation and/or re-simulation. The simulation system may use the object's state, commands, and/or information, in addition to using traffic AI, pedestrian AI, and/or other features of the simulation platform, to generate or update the simulated environment (e.g., to a current state). The current state may be passed to the KPI framework (e.g., at the same time as the driving commands being passed to the ego-object dynamics 808, in some embodiments), and the KPI framework 810 may monitor and evaluate the current simulation and/or re-simulation. In some examples, the codec(s) 804 may buffer simulation data to increase performance and/or reduce latency of the system.

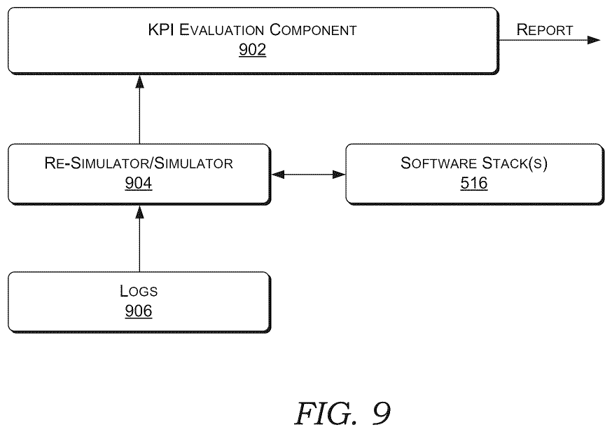

Now referring to FIG. 9, FIG. 9 includes a data flow diagram for key performance indicator (KPI) analysis and observation, in accordance with some embodiments of the present disclosure. A KPI evaluation component may evaluate the performance of the virtual object(s) (e.g., vehicles, robots, etc.). Logs 906 may be generated and passed to re-simulator/simulator 904. The re-simulator/simulator 904 may provide sensor data to the software stack(s) 516 which may be executed using HIL, SIL, or a combination thereof. The KPI evaluation component 902 may use different metrics for each simulation or re-simulation instance. For examples, for re-simulation, KPI evaluation component may provide access to the original re-played CAN data and/or the newly generated CAN data from the software stack(s) 516 (e.g., from HIL or SIL). In some examples, performance could be as simple as testing that the new CAN data does not create a false positive—such as by triggering Automatic Emergency Braking (AEB), or another ADAS functionality. For example, the KPI evaluation component 902 may determine whether the new CAN data triggers a blind spot warning, or a lane departure warning. As a result, the system may help reduce the false positives that plague conventional ADAS systems. The KPI evaluation component 902 may also determine whether the new CAN data fails to trigger a warning that should have been implemented.

In some examples, the KPI evaluation component 902 may also provide for more complex comparisons. For example, the KPI evaluation component 902 may be as complex as running analytics on the two differing CAN streams to find deviations. The KPI evaluation component 902 may compare the new CAN data against the original CAN data, and may evaluate both trajectories to determine which trajectory would best meet the systems safety goals. In some examples, the KPI evaluation component 902 may use one or more methods described in U.S. Provisional Application No. 62/625,351, or U.S. Non-Provisional patent application Ser. No. 16/256,780, each hereby incorporated by reference in its entirety. In other examples, the KPI Evaluation component 902 may use one or of the methods described in U.S. Provisional Application No. 62/628,831, or U.S. Non-Provisional patent application Ser. No. 16/269,921, each hereby incorporated by reference in its entirety. For example, safety procedures may be determined based on safe time of arrival calculations.

In some examples, the KPI evaluation component 902 may also use the method described in U.S. Provisional Application No. 62/622,538 or U.S. Non-Provisional patent application Ser. No. 16/258,272, hereby incorporated by reference in its entirety, which may be used to detect hazardous driving using machine learning. For example, machine learning and deep neural networks (DNNs) may be used for redundancy and for path checking e.g., for a rationality checker as part of functional safety for autonomous driving. These techniques may be extended for use with the KPI evaluation component 902 to evaluate the performance of the system.

The KPI Evaluation component may also use additional approaches to assess the performance of the system. For example, the KPI evaluation component 902 may consider whether the time to arrival (TTA) in the path of the cross-traffic is less than a threshold time—e.g. two seconds. The threshold may vary depending on the speed of the vehicle, road conditions, weather, traffic, and/or other variables. For example, the threshold duration may be two seconds for speeds up to twenty MPH, and one second for any greater speed. Alternatively, the threshold duration may be reduced or capped whenever the system detects hazardous road conditions such as wet roads, ice, or snow. In some examples, hazardous road conditions may be detected by a DNN trained to detect such conditions.

With respect to simulation, the KPI evaluation component may include an API, as described herein. The KPI evaluation component 902 may include additional inputs and/or provide more functionality. For example, the simulator may be able to share the “ground truth” for the scene, and may be able to determine the capability of the virtual object with respect to avoiding collisions, staying-in-lane, and/or performing other behaviors. For examples, the KPI evaluation component 902 may be more than a passive witness to the experiment, and may include an API to save the state of any ongoing simulation, change state or trigger behaviors, and continue with those changes. This may allow the KPI evaluation component to not only evaluate the car performance but to try to explore the space of potential dangerous scenarios.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to allow the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to allow autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LiDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), one or more occupant monitoring system (OMS) sensor(s) 1001 (e.g., one or more interior cameras), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

Cameras with a field of view that include portions of the interior environment within the cabin of the vehicle 1000 (e.g., one or more OMS sensor(s) 1001) may be used as part of an occupant monitoring system (OMS) such as, but not limited to, a driver monitoring system (DMS). For example, OMS sensors (e.g., the OMS sensor(s) 1001) may be used (e.g., by the controller(s) 1036) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation allowing any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), and very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LiDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1016 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to allow communication with peripherals, audio codecs, power management, and/or other devices. The SoC(s) 1004 may be used to process data from cameras (e.g., connected over Gigabit Multimedia Serial Link and Ethernet), sensors (e.g., LiDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to allow wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated using the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LiDAR sensor(s) 1064. The LiDAR sensor(s) 1064 may be used for object and pedestrian detection, emergency braking, collision avoidance, and/or other functions. The LiDAR sensor(s) 1064 may be functional safety level ASIL B. In some examples, the vehicle 1000 may include multiple LiDAR sensors 1064 (e.g., two, four, six, etc.) that may use Ethernet (e.g., to provide data to a Gigabit Ethernet switch).

In some examples, the LiDAR sensor(s) 1064 may be capable of providing a list of objects and their distances for a 360-degree field of view. Commercially available LiDAR sensor(s) 1064 may have an advertised range of approximately 1000 m, with an accuracy of 2 cm-3 cm, and with support for a 1000 Mbps Ethernet connection, for example. In some examples, one or more non-protruding LiDAR sensors 1064 may be used. In such examples, the LiDAR sensor(s) 1064 may be implemented as a small device that may be embedded into the front, rear, sides, and/or corners of the vehicle 1000. The LiDAR sensor(s) 1064, in such examples, may provide up to a 120-degree horizontal and 35-degree vertical field-of-view, with a 200 m range even for low-reflectivity objects. Front-mounted LiDAR sensor(s) 1064 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1000. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may allow the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LiDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. As such, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(D) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more embodiments described below may be combined with one or more other embodiments. In an example embodiment, one or more processors comprise one or more processing units to: obtain simulation data representative of a simulated three-dimensional (3D) environment, the simulated 3D environment including one or more objects; obtain virtual sensor data generated using a virtual radar sensor within the simulated 3D environment, the virtual sensor data at least partially representing one or more interactions of one or more virtual radar signals emitted from the virtual radar sensor with the one or more objects within the simulated 3D environment; compute one or more attribute values of the virtual sensor data; and based at least on the one or more attribute values, populate a data structure representative of an output of the virtual radar sensor.

In some embodiments, the one or more processing units are further to: compute the one or more attribute values at least partially in response to the virtual radar sensor emitting the one or more virtual radar signals, and wherein the one or more attribute values include at least one of: an indication of a location of the one or more objects, a velocity of the one or more objects, an identifier of one or more materials of a surface of the one or more objects, a behavioral characteristic of the one or more virtual radar signals when interacting with the one or more materials, a round trip distance associated with the one or more virtual radar signals, and a roundtrip velocity associated with the one or more virtual radar signals.

In some embodiments, the data structure represents a vector with a plurality of dimensions, and wherein the plurality of dimensions include two or more of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

In some embodiments, the virtual sensor data is computed by ray tracing at least one of: a propagation of the one or more virtual radar signals through the simulated 3D environment. In some embodiments, the virtual sensor data is indicative of energy transport simulation by converting a portion of the virtual sensor data to estimated energy of the one or more virtual radar signals based on at least one of a polarization or a phase.

In some embodiments, the one or more processing units are further to: track how the one or more virtual radar signals scatter in one or more directions upon hitting one or more virtual surfaces of the one or more objects according to a Material Bidirectional Scattering Distribution Function (BSDF), and wherein the one or more attribute values are extracted based at least on tracking how the one or more virtual radar signals scatter in the one or more directions upon hitting the one or more virtual surfaces of the one or more objects according to the BSDF.

In some embodiments, the virtual radar sensor is disposed on an exterior surface of a virtual ego machine, and wherein virtual sensor data represents data that is simulated as the virtual ego machine traverses the simulated 3D environment.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system incorporating one or more virtual machines (VMs); a system implemented at least partially in a data center; or a system implemented at least partially using cloud computing resources.

In one embodiments, a data center system comprises a plurality of computing nodes, wherein two or more computing nodes of the plurality of computing nodes comprises one or more graphics processing units (GPUs) to: implement a simulated environment that includes one or more objects; obtain, via a virtual radar sensor within the simulated environment, virtual sensor data that at least partially represents one or more interactions of one or more virtual radar signals emitted from the virtual radar sensor with the one or more objects within the simulated environment; and extract one or more attribute values from the virtual sensor data.

In some embodiments, the one or more attribute values include at least one of: an indication of a location of the one or more objects in the simulated environment, a velocity vector of the one or more objects, an identifier of one or more materials of the one or more objects, a behavioral characteristic of the one or more virtual radar signals when interacting with the one or more materials, a round trip distance associated with the one or more virtual radar signals, and a roundtrip velocity associated with the one or more virtual radar signals.

In some embodiments, the one or more computing nodes are further to: populate a data structure representative of an output of the virtual radar sensor, wherein the data structure represents a vector with a plurality of dimensions, and wherein the plurality of dimensions include two or more of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

In some embodiments, the virtual sensor data is computed by ray tracing a propagation of the one or more virtual radar signals through the simulated environment and one or more interactions of between the virtual radar signals with the one or more objects. In some embodiments, the virtual sensor data is indicative of energy transport simulation by converting a portion of the virtual sensor data to estimated energy of the one or more virtual radar signals based on at least one of a polarization or a phase.

In some embodiments, the one or more computing nodes are further to: track how the one or more virtual radar signals scatter in one or more directions upon hitting one or more virtual surfaces of the one or more objects according to a Material Bidirectional Scattering Distribution Function (BSDF), and wherein the one or more attribute values are extracted based at least on tracking how the one or more virtual radar signals scatter in the one or more directions upon hitting the one or more virtual surfaces of the one or more objects according to the BSDF.

In some embodiments, the virtual radar sensor is disposed on an exterior surface of a virtual ego machine, and wherein virtual sensor data represents data that is captured as the virtual ego machine traverses the simulated 3D environment.

In some embodiments, the data center system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system incorporating one or more virtual machines (VMs).

In an embodiments, a method comprises: obtaining simulation data representative of a simulated environment that includes one or more objects; obtaining virtual sensor data generated using a virtual radar sensor within the simulated environment, the virtual sensor data at least partially representing one or more interactions of one or more virtual radar signals emitted from the virtual radar sensor with the one or more objects within the simulated environment; and based at least on the one or more interactions of the one or more virtual radar signals with the one or more objects within the simulated environment, populating a data structure representative of an output of the virtual radar sensor.

In some embodiments, the method further comprises: extracting one or more attribute values, and wherein the one or more attribute values include at least one of: an indication of a location of the one or more objects, a velocity vector of the one or more objects, an identifier of one or more materials of the one or more objects, a behavioral characteristic of the one or more virtual radar signals when interacting with the one or more materials, a round trip distance associated with the one or more virtual radar signals, and a roundtrip velocity associated with the one or more virtual radar signals, and wherein the populating of the data structure is further based at least on the extracting of the one or more attribute values.

In some embodiments, the data structure includes two or more dimensions of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system incorporating one or more virtual machines (VMs); a system implemented at least partially in a data center; or a system implemented at least partially using cloud computing resources.

What is claimed is:

1. One or more processors comprising one or more processing units to:
obtain simulation data representative of a simulated three-dimensional (3D) environment, the simulated 3D environment including one or more objects;
obtain virtual sensor data generated using a virtual radar sensor within the simulated 3D environment, the virtual sensor data at least partially representing one or more interactions of one or more virtual radar signals emitted from the virtual radar sensor with the one or more objects within the simulated 3D environment;
compute one or more attribute values of the virtual sensor data; and
based at least on the one or more attribute values, populate a data structure representative of an output of the virtual radar sensor.

2. The one or more processors of claim 1, wherein the one or more processing units are further to: compute the one or more attribute values at least partially in response to the virtual radar sensor emitting the one or more virtual radar signals, and wherein the one or more attribute values include at least one of: an indication of a location of the one or more objects, a velocity of the one or more objects, an identifier of one or more materials of a surface of the one or more objects, a behavioral characteristic of the one or more virtual radar signals when interacting with the one or more materials, a round trip distance associated with the one or more virtual radar signals, and a roundtrip velocity associated with the one or more virtual radar signals.

3. The one or more processors of claim 1, wherein the data structure represents a vector with a plurality of dimensions, and wherein the plurality of dimensions include two or more of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

4. The one or more processors of claim 1, wherein the virtual sensor data is computed by ray tracing at least one of: a propagation of the one or more virtual radar signals through the simulated 3D environment.

5. The one or more processors of claim 1, wherein the virtual sensor data is indicative of energy transport simulation by converting a portion of the virtual sensor data to estimated energy of the one or more virtual radar signals based on at least one of a polarization or a phase.

6. The one or more processors of claim 1, wherein the one or more processing units are further to:
track how the one or more virtual radar signals scatter in one or more directions upon hitting one or more virtual surfaces of the one or more objects according to a Material Bidirectional Scattering Distribution Function (BSDF), and wherein the one or more attribute values are extracted based at least on tracking how the one or more virtual radar signals scatter in the one or more directions upon hitting the one or more virtual surfaces of the one or more objects according to the BSDF.

7. The one or more processors of claim 1, wherein the virtual radar sensor is disposed on an exterior surface of a virtual ego machine, and wherein virtual sensor data represents data that is simulated as the virtual ego machine traverses the simulated 3D environment.

8. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system incorporating one or more virtual machines (VMs);
a system implemented at least partially in a data center; or
a system implemented at least partially using cloud computing resources.

9. A data center system comprising a plurality of computing nodes, wherein two or more computing nodes of the plurality of computing nodes comprises one or more graphics processing units (GPUs) to:
implement a simulated environment that includes one or more objects;
obtain, via a virtual radar sensor within the simulated environment, virtual sensor data that at least partially represents one or more interactions of one or more virtual radar signals emitted from the virtual radar sensor with the one or more objects within the simulated environment; and
extract one or more attribute values from the virtual sensor data.

10. The data center system of claim 9, wherein the one or more attribute values include at least one of: an indication of a location of the one or more objects in the simulated environment, a velocity vector of the one or more objects, an identifier of one or more materials of the one or more objects, a behavioral characteristic of the one or more virtual radar signals when interacting with the one or more materials, a round trip distance associated with the one or more virtual radar signals, and a roundtrip velocity associated with the one or more virtual radar signals.

11. The data center system of claim 9, wherein the one or more computing nodes are further to:
populate a data structure representative of an output of the virtual radar sensor, wherein the data structure represents a vector with a plurality of dimensions, and wherein the plurality of dimensions include two or more of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

12. The data center system of claim 9, wherein the virtual sensor data is computed by ray tracing a propagation of the one or more virtual radar signals through the simulated environment and one or more interactions of between the virtual radar signals with the one or more objects.

13. The data center system of claim 9, wherein the virtual sensor data is indicative of energy transport simulation by converting a portion of the virtual sensor data to estimated energy of the one or more virtual radar signals based on at least one of a polarization or a phase.

14. The data center system of claim 9, wherein the one or more computing nodes are further to:
track how the one or more virtual radar signals scatter in one or more directions upon hitting one or more virtual surfaces of the one or more objects according to a Material Bidirectional Scattering Distribution Function (BSDF), and wherein the one or more attribute values are extracted based at least on tracking how the one or more virtual radar signals scatter in the one or more directions upon hitting the one or more virtual surfaces of the one or more objects according to the BSDF.

15. The data center system of claim 9, wherein the virtual radar sensor is disposed on an exterior surface of a virtual ego machine, and wherein virtual sensor data represents data that is captured as the virtual ego machine traverses the simulated 3D environment.

16. The data center system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system incorporating one or more virtual machines (VMs).

17. A method comprising:
obtaining simulation data representative of a simulated environment that includes one or more objects;
obtaining virtual sensor data generated using a virtual radar sensor within the simulated environment, the virtual sensor data at least partially representing one or more interactions of one or more virtual radar signals emitted from the virtual radar sensor with the one or more objects within the simulated environment; and
based at least on the one or more interactions of the one or more virtual radar signals with the one or more objects within the simulated environment, populating a data structure representative of an output of the virtual radar sensor.

18. The method of claim 17, further comprising:
extracting one or more attribute values, and wherein the one or more attribute values include at least one of: an indication of a location of the one or more objects, a velocity vector of the one or more objects, an identifier of one or more materials of the one or more objects, a behavioral characteristic of the one or more virtual radar signals when interacting with the one or more materials, a round trip distance associated with the one or more virtual radar signals, and a roundtrip velocity associated with the one or more virtual radar signals, and wherein the populating of the data structure is further based at least on the extracting of the one or more attribute values.

19. The method of claim 17, wherein the data structure includes two or more dimensions of: a range dimension representing a distance between the virtual radar sensor and the one or more objects, a Doppler dimension representing one or more velocities of the one or more objects, an azimuth angle representing a horizontal direction of the one or more objects relative to an orientation of the virtual radar sensor, and an elevation angle representing a vertical direction of the one or more objects relative to the orientation of the virtual radar sensor.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system incorporating one or more virtual machines (VMs);
a system implemented at least partially in a data center; or
a system implemented at least partially using cloud computing resources.
